(19) United States
(12) Patent Application Publication
(10) Pub. No.: US 2024/0189175 A1
(43) Pub. Date: Jun. 13, 2024

(54) ELECTROMECHANICAL AMBULATORY ASSIST DEVICE

(71) Applicant: NIKE, Inc., Beaverton, OR (US)

(72) Inventors: Christopher Andon, Portland, OR (US); Lucie Browning, Portland, OR (US); Joseph B. Gault, West Linn, OR (US); Timothy P. Hopkins, Tustin, CA (US); Bobby LeGaye, Portland, OR (US); Austin J. Orand, Portland, OR (US); Peter P. Williams, II, Portland, OR (US); Kimberly A. Sokol, Vancouver, WA (US)

(73) Assignee: NIKE, Inc., Beaverton, OR (US)

(21) Appl. No.: 18/444,340

(22) Filed: Feb. 16, 2024

Related U.S. Application Data
(63) Continuation of application No. PCT/US23/31679, filed on Aug. 31, 2023.
(60) Provisional application No. 63/374,170, filed on Aug. 31, 2022.

(51) Int. Cl. A61H 3/00; A61H 1/02

(52) U.S. Cl. CPC A61H 3/00; A61H 1/0262; A61H 2201/1207; A61H 2201/1481; A61H 2201/163; A61H 2201/1642; A61H 2201/165; A61H 2201/5007; A61H 2201/5084; A61H 2201/5097; A61H 2230/625

(57) ABSTRACT

An ambulatory assist device includes: an ambulatory engine configured to be mounted at a waist of a user, the ambulatory engine comprising a motor and a controller; an article of clothing wearable by the user and integrated with one or more cables coupled to the motor; and one or more shoes wearable on feet of the user, each shoe coupled to a respective cable via a connector. The controller is configured to: receive sensor data from one or more sensors located on the user; analyze the sensor data to determine gait phases of the user; selectively control the motor to tension the one or more cables and provide an assistive force to the feet of the user during a push off phase of a gait cycle.

### CROSS-REFERENCE TO RELATED APPLICATIONS

This application is a continuation of international application No. PCT/US2023/031679, filed Aug. 31, 2023, which claims the benefit of priority to U.S. Provisional Patent No. 63/374,170, filed 31 Aug. 2022, both of which are incorporated by reference in their entirety and for all that they disclose.

### TECHNICAL FIELD

The present disclosure generally relates to an electromechanical device that is configured to assist or augment the natural ambulatory movement of a user, and methods of using the same.

### BACKGROUND

The human ambulatory bipedal gait is a complex yet efficient cyclic pattern of coordinated lower limb motion that propels the body forward with each. During normal walking, the ankle joint plays a crucial role in nearly all aspects of locomotion. The ankle controls motion, absorbs shoek, stabilizes stance, conserves energy, and provides propulsion. A single gait cycle consists of two main phases—stance and swing. It begins at initial contact as the heel strikes the ground. Controlled ankle motion during loading response is key to absorbing shoek and decelerating the foot after heel strike. The ankle then provides stability as body weight shifts forward over the planted foot. As the stance phase nears completion, the ankle releases stored elastic energy, providing propulsion to push-off into the swing phase. During swing, ankle dorsiflexors lift the foot to clear the ground.

Wearable robotic exoskeletons aim to augment human strength, provide gait retraining after injury, or improve movement efficiency. Most lower limb exoskeletons utilize rigid, full-leg metal structures to entirely support the user's body weight and enable tasks exceeding natural strength limits. While rigid exoskeletons can empower healthy and physically disabled individuals alike, they have drawbacks in coordinating smooth, natural motions. Issues arise from joint misalignment with the biological joints, restricted natural joint motion due to fewer degrees of freedom, and added weight/inertia not compensated by the device. Slow actuation and lack of accurate intent detection also impede real-world usefulness.

### BRIEF DESCRIPTION OF THE DRAWINGS

FIG. 1 schematically illustrates an athlete wearing an ambulatory assist device while running on a trail.

FIG. 2 schematically illustrates a side profile view of an embodiment of a user wearing an ambulatory assist device.

FIG. 3 schematically illustrates a side profile view of an embodiment of an article of footwear having a connector for receiving a tension cable, where the connector is integrated into a heel counter and located on a posterior end portion of the article.

FIG. 4 schematically illustrates a side profile, partial cut-away view of an embodiment of an article of footwear having a connector for receiving a tension cable, where the connector is integrated into an upward curving sole plate and located on a posterior end portion of the article.

FIG. 5 schematically illustrates a side profile view of an embodiment of an article of footwear having a sole plate with a posteriorly extending protrusion for coupling with a tensile cable.

FIG. 6A schematically illustrates a side profile view of an embodiment of an article of footwear with a heel-lifting sole configuration and that is positioned in an un-lifted state.

FIG. 6B schematically illustrates a side profile view of the article of footwear of FIG. 6A that is positioned in a heel-lifted state.

FIG. 7A schematically illustrates a side profile view of an embodiment of an article of footwear with a heel-lifting sole configuration and that is positioned in an un-lifted state.

FIG. 7B schematically illustrates a side profile view of the article of footwear of FIG. 7A that is positioned in a heel-lifted state.

FIG. 8A schematically illustrates a rear view of a user wearing an embodiment of an ambulatory assist device.

FIG. 8B schematically illustrates a side view of the user of FIG. 8A

FIG. 9A schematically illustrates a side view of a user wearing an embodiment of an ambulatory assist device with a partial plantarflexion.

FIG. 9B schematically illustrates the user of FIG. 9A with a greater plantarflexion that is assisted by an ambulatory assist device.

FIG. 10A schematically illustrates a side view of a user wearing an ambulatory assist device and a plurality of sensor systems.

FIG. 10B schematically illustrates a functional diagram of an ambulatory engine from FIG. 10A in communication with a plurality of sensors and remote devices.

FIG. 11A schematically illustrates a motor mechanism for driving a plurality of actuator cables using a single motor, with the motor specifically driving a first spooling mechanism for a first cable.

FIG. 11B schematically illustrates the motor mechanism of FIG. 11A with the motor driving a second spooling mechanism for a second cable.

FIG. 12 schematically illustrates a prospective view of a footwear senor embedded in a sole structure of an article of footwear.

FIG. 13 schematically illustrates a functional diagram of a footwear sensor such as illustrated in FIG. 12.

FIG. 14A schematically illustrates a profile view of an airbag-like fluid filled cushioning element for use in a sole structure of an article of footwear, the cushioning element including a plurality of integrated flexible pressure sensors.

FIG. 14B schematically illustrates a side profile view of the airbag-like fluid filled cushioning element of FIG. 14A with a user's foot deforming at least two of the flexible pressure sensors.

FIG. 15 schematically illustrates a rear view of a shirt-like article of apparel with a plurality of integrated sensors.

FIG. 16A schematically illustrates a rear view of a pants-like article of apparel with a plurality of integrated sensors.

FIG. 16B schematically illustrates a front view of the article of apparel of FIG. 16A.

FIG. 17A schematically illustrates a view of a user with a jump assist device in a loaded state.

FIG. 17B schematically illustrates a view of the user of FIG. 17B with the jump assist deployed to propel the user upward.

FIG. 18 schematically illustrates a user with a jump assist playing basketball.

FIG. 19 schematically illustrates a user actively training with a powered follower-type assist device that can actively assist and/or resist the user's motion.

FIG. 20 schematically illustrates a user pulling passengers on a rickshaw-like follower assist device that can assist the user to improve the user's overall endurance and safety.

FIG. 21 schematically illustrates a functional diagram of a follower-type assist device in communication with a plurality of local and remote devices.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

The present disclosure is directed to the structure and operation of an ambulatory assist device that is configured to augment the natural walking or running motion of a user. In recent years, electronic assist devices have become increasingly popular in combination with traditionally manual forms of transportation. For example, bicycles have been augmented with pedal assist motors and it's common for electric scooters to zip around urban environments upwards of 15 mph. The present disclosure contemplates that similar electronic assist can be utilized with the most basic form of human transportation, walking/running.

While powered exoskeleton designs exist for the purpose of enhancing human strength and for clinical physical rehabilitation, the existing designs often rely on bulky structure and equipment that is simply not suitable for more general consumer use. The present designs and techniques are an attempt to streamline and minimize the antiquated exoskeleton structure in an effort to achieve mass consumer adoption.

In general, the present designs are not intended as a full replacement for the user's natural ambulatory motion, but rather they are intended simply as an assist device to improve a user's overall endurance or to supplement (or challenge) a user's maximum effort during training. For example, in one configuration, one or more sensors may be operative to detect a user's physical form during a training activity. If the system perceives that the user is overexerting at the expense of proper form, it may supplement the user's motion while simultaneously alerting the user about their form.

Referring to the figures, FIG. 1 generally illustrates an embodiment of a user 10 running on a mountain side trail 12 while aided by an ambulatory assist device 20. As generally shown, and described in greater detail below, this assist device 20 may act on the user's foot/ankle 22 to augment and/or supplement the user's natural push-off/plantarflexion motion. In doing so, the user 10 may not feel the need to overexert, or else may be capable of running a longer distance than would otherwise be possible. Said differently, the assist device 20 would operatively reduce the metabolic cost of running to enable the user 10 to run further, faster, and/or at a reduced risk of injury.

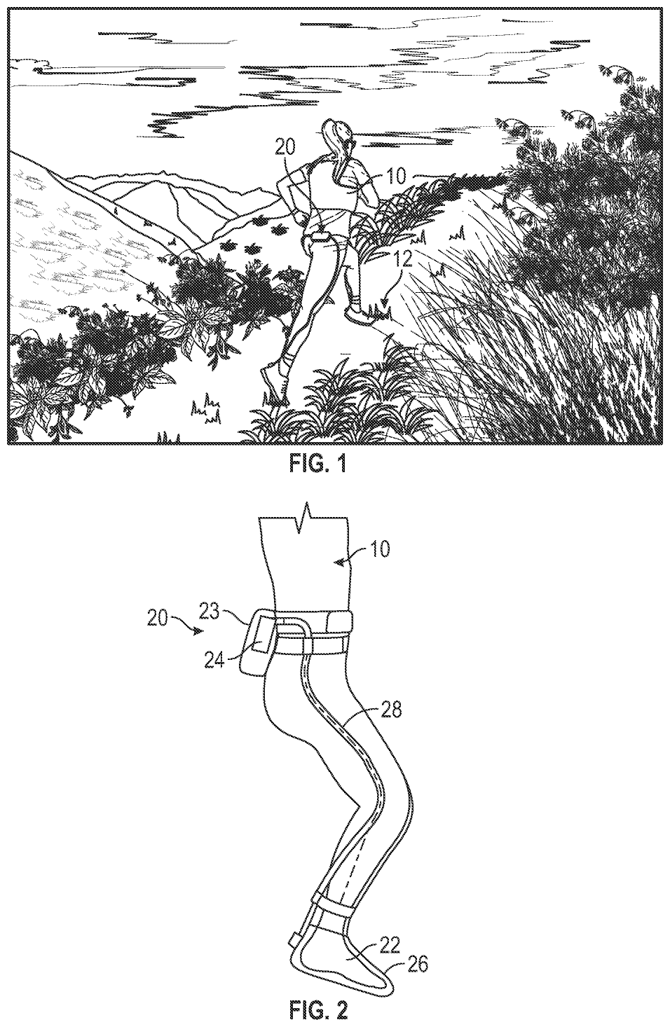

FIG. 2 schematically illustrates an ambulatory assist device 20 similar to that shown and FIG. 1. This assist device 20 generally includes an ambulatory engine 23 having at least an onboard motor/actuator 24 operative to apply a force to the user's foot 22 (i.e. via a donned article of footwear 26) and/or about the user's ankle. In some embodiments, this applied force may be applied to the article of footwear 26 by tensioning one or more cables 28 extending between the motor/actuator 24 and the article of footwear 26. If timed correctly, this force/torque about the user's ankle may assist or supplement the user's own efforts during the push-off stage of their gait.

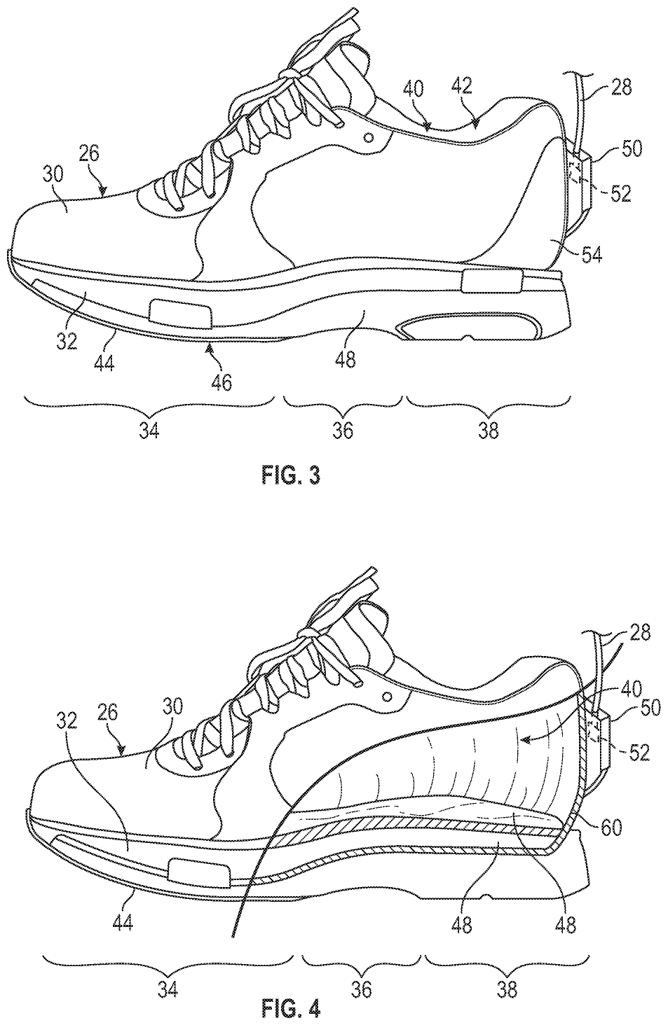

FIGS. 3-7 illustrate various embodiments of an article of footwear 26 that may be operative to receive an assistive force/torque from a coupled motor 24 via an intermediate cable 28. While the article of footwear 26 is illustrated for discussion as an athletic shoe or “sneaker,” it should be recognized that this is simply one example application. In other applications, however, the present assist device 20 may be incorporated into other styles of footwear, and/or may be incorporated into any logically relevant articles of apparel. As used herein, the terms “shoe” and “footwear”, including permutations thereof, may be used interchangeably and synonymously to reference any suitable type of garment worn on a human foot. Lastly, features presented in the drawings are not necessarily to scale and are provided purely for instructional purposes. Thus, the specific and relative dimensions shown in the drawings are not to be construed as limiting.

The representative article of footwear in FIG. 3 (also generically referred to as a shoe 26) is generally depicted as a bipartite construction that is primarily composed of a foot-receiving upper 30 mounted on top of a subjacent sole structure 32. For ease of reference, the shoe 26 may be divided into three anatomical regions: a forefoot region 34, a midfoot region 36, and a hindfoot (heel) region 38. In accordance with recognized anatomical classification, the forefoot region 34 is located at the front/anterior portion of the shoe 26 and generally corresponds with the phalanges (toes), metatarsals, and any interconnecting joints thereof. The midfoot region 36 is located between the forefoot and heel regions 34 and 38 and generally corresponds with the cuneiform, navicular and cuboid bones (i.e., the arch area of the foot). The heel region 38, in contrast, is located at the rear/posterior portion of the shoe 26 and generally corresponds with the talus (ankle) and calcaneus (heel) bones. While only a single shoe 26 for a right foot of a user is shown in FIG. 3, a mirrored, substantially identical counterpart for a left foot of a user may be provided. Recognizably, the shape, size, material composition, and method of manufacture of the shoe 26 may be varied, singly or collectively, to accommodate practically any conventional or nonconventional footwear application.

With continued reference to FIG. 3, the upper 30 is depicted as having a shell-like construction for encasing a human foot within an internal cavity 40. As illustrated, the upper 30 generally includes an ankle opening 42 that permits ingress of a wearer's foot into the internal cavity 40. The sole structure 32 is rigidly secured to the upper 30 such that the sole structure 32 extends between the upper 30 and a support/ground surface upon which a user stands. In effect, the sole structure 32 functions as an intermediate support platform that separates and protects the underside of the user's foot from the ground.

Typical sole structures may include an outsole 44 provided on a ground-engaging surface 46 of the sole structure 32 and a cushioning midsole 48 attached to the outsole 44. The midsole 48 may include one or more materials or structures that are adapted to attenuate ground reaction forces and provide cushioning for the foot 22. For example, the midsole 48 may include one or more foam cushioning structure, fluid-filled cushioning structures, air-filled cushioning structure, or the like. Additionally, the sole structure 32 may also include structures or may otherwise be designed to provide traction, impart stability, and help to limit various foot motions, such as inadvertent foot inversion and eversion. In some embodiments, the sole structure 32 may be attached to the upper 30, for example, via an adhesive or other typical joining means.

As further illustrated in FIG. 3, in some embodiments, the article of footwear 26 may include a cable connector 50 that is adapted to selectively receive and couple with a terminal end 52 of the intermediate cable 28. It is through the connector 50 that the cable will ultimately be able to apply a force to the shoe 26. Moreover, this force may apply a larger torque to the user's foot and about the user's ankle as the connector 50 is spaced further from the ankle (which is an approximate center of the ankle opening 42. In some embodiments, the cable connector 50 may include one or more hooks, latches, quick disconnect features, butterfly clutches, quarter-turn fasteners, and/or other suitable coupling mechanisms for providing a quick engagement of the terminal end 52 of the cable 28 with the shoe 26. In an effort to provide the largest possible moment arm around the user's ankle, the cable connector 50 may be provided on a posterior/rear-most portion of the upper 30 or sole structure 32 within the heel region 38. To provide the cable connector 50 with a strong, structural attachment to the shoe 26, in one configuration, the cable connector 50 may be integral to a polymeric heel counter 54 that extends upward from the sole structure 32, such as shown in FIG. 3.

In some embodiments, such as illustrated in FIG. 4, the connector 50 may be integral with or affixed to a plate 60 that extends along at least a portion of the sole structure including in the heel region 38. In some embodiments, this plate 60 may extend from the cable connector 50 and across some or all of the heel region 38, mid foot region 36, and/or forefoot region 34. The plate 60 may be embedded within the foam midsole 48, in some configurations may form some or all of an outsole 44 of the sole structure 32. Likewise, in some configurations, the plate 60 may be in contact with an upper surface of the foam midsole 48 such that it extends between the midsole 48 and the upper 30. US Patent Pub No. 2023/0124653 (the '653 application) provides examples of various other shoe 26, plate 60, and connector 50 designs that may be used with the presently described ambulatory assist device 20. The '653 application is incorporated by reference in its entirety and for all that it discloses.

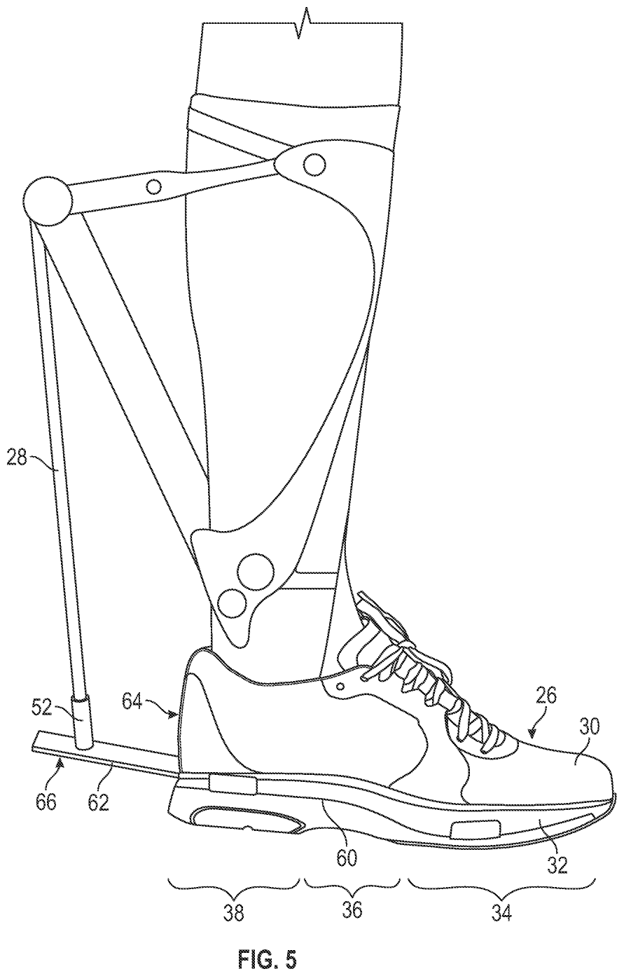

As noted above, to provide the largest moment arm, the cable connector 50 should be spaced a maximum permissible distance from an axis of rotation of the user's ankle. While placement on the heel counter 54 is one possible configuration, FIG. 5 illustrates a different configuration where the integral sole plate 60 includes a projection 62 that extends rearward (posteriorly) from the rear-most terminal end 64 of the upper 30. By connecting the terminal end 52 of the cable 28 with the end portion 66 of the plate projection 62, additional space may be provided between the cable connection and the user's ankle, which may result in greater possible applied assistive torque (or a similar torque at a lower applied force).

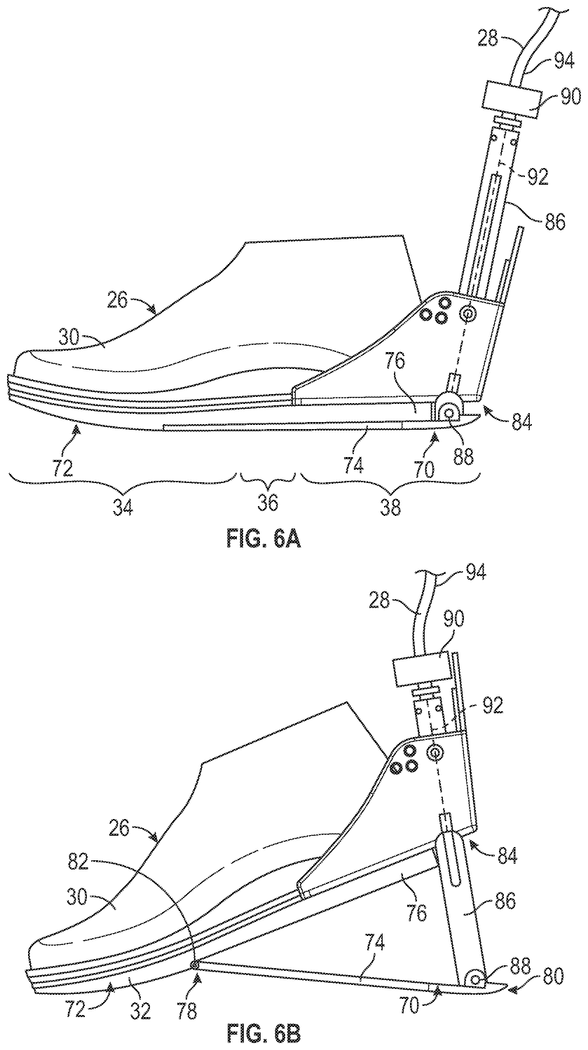

FIGS. 6A and 6B illustrate a different configuration of an article of footwear 26 that is configured to assist a user in performing a planter flexion/push-off motion during a standard gait. In this embodiment, at least a portion 70 of the sole structure 32 within the heel region 38 is articulated relative to a portion 72 of the sole structure 32 in the forefoot region 34 (i.e., the “forefoot sole portion 72”) to aid the user in lifting their heel. As best illustrated in FIG. 6B, within the heel region 38, there is both a lower sole structure 74 and an upper sole structure 76, with the upper sole structure 76 being located between the lower sole structure 74 and the upper 30. The lower sole structure 74 includes an anterior end portion 78 and a posterior end portion 80. The anterior end portion 78 of the lower sole structure 74 is pivotably connected with the forefoot sole portion 72 at a pivotable joint 82. In some embodiments, this pivotable joint 82 may comprise a physical hinge (e.g. a pin-type rotatable joint). In other embodiments, the pivotable joint 82 may comprise a compliant joint or “living hinge,” which relies on a material elasticity or compliant structure to facilitate repeatable rotatable motion.

As further shown and FIGS. 6A and 6B, a posterior portion 84 of the upper sole structure 76 may be coupled with and slidable along a lifting strut 86, with the lifting strut 86 being pivotably coupled to the posterior end portion 80 of the lower sole structure 74 at a joint 88. The lifting strut 86 may include a terminal end portion 90 that selectively receives a portion of the intermediate cable 28 and/or a portion of a conduit through which the cable 28 may pass. For example, in one configuration, the intermediate cable 28 is a Bowden-style cable (i.e., a type of flexible cable used to transmit mechanical force or energy by the movement of an inner cable 92 relative to a hollow outer cable housing 94). The outer cable housing 94 of a Bowden-style cable typically has a composite construction that includes, for example, an inner lining, a longitudinally incompressible layer such as a helical winding or a sheaf of steel wire, and a protective outer covering. In such a design, the outer cable housing 94 may be secured to the terminal end portion 90 of the lifting strut 86, while the inner cable 92 extends through and is secured to a cable connector 50 on the sole structure 32 or upper 30, or to a portion of the upper sole structure 76.

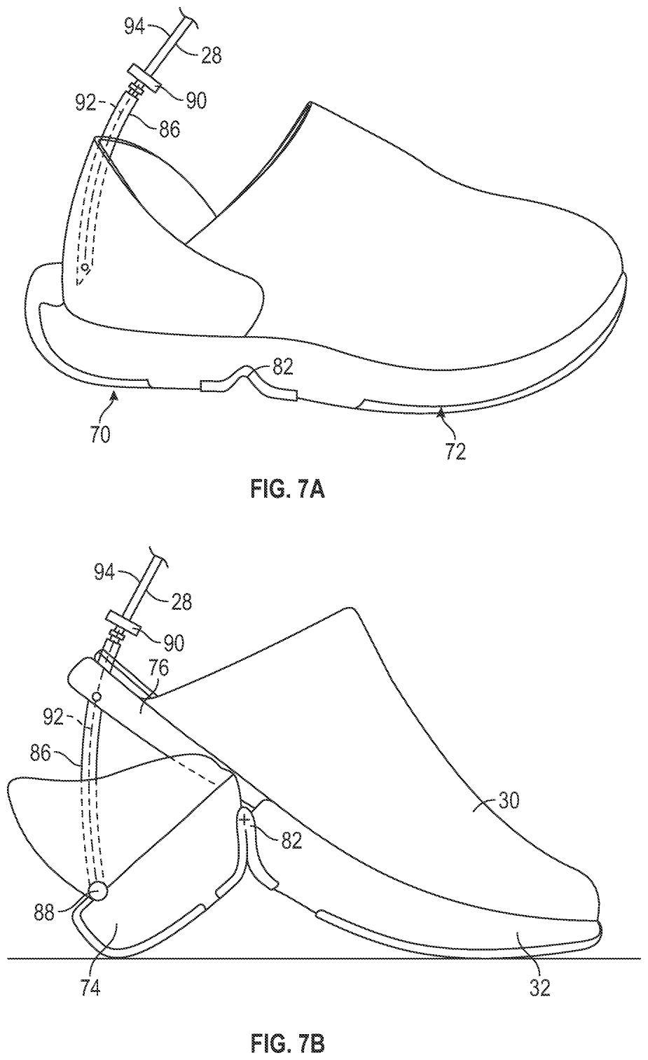

As shown in FIG. 6B, upon tensioning the inner cable 92 relative to the housing 94 and terminal end portion 90 of the lifting strut 86, the heel region 38 of the upper 30 and upper sole structure 76 may separate from the lower sole structure 74 and cause a plantarflexion-type motion. A shoe design that may be readily adapted to this heel lift assist is described in US patent application number 2020/0205512 (the '512 application), which is incorporated by reference in its entirety. FIGS. 7A-7B provide a representative embodiment of the shoe described in the '512 application, though augmented with the lifting structure illustrated and described with respect to FIGS. 6A and 6B.

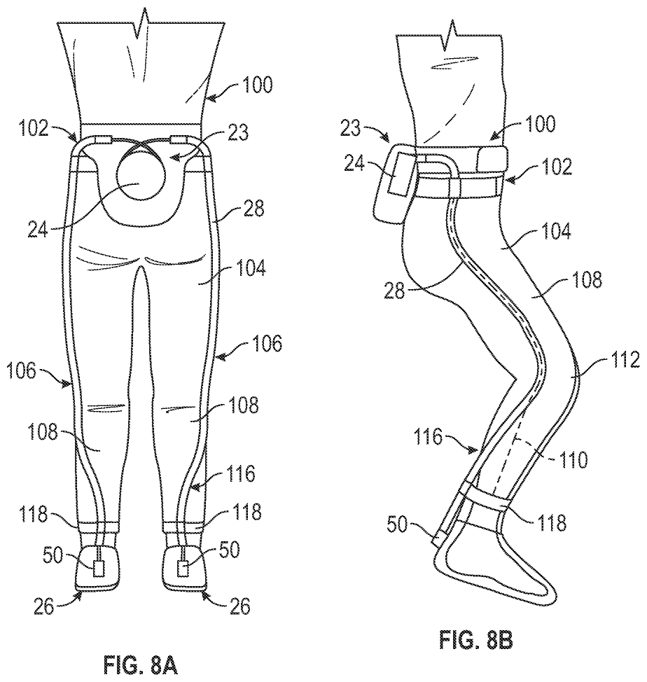

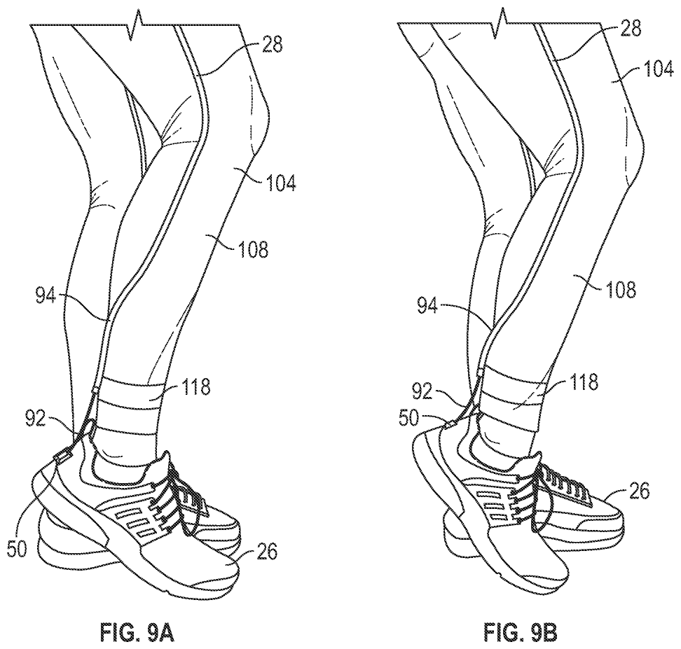

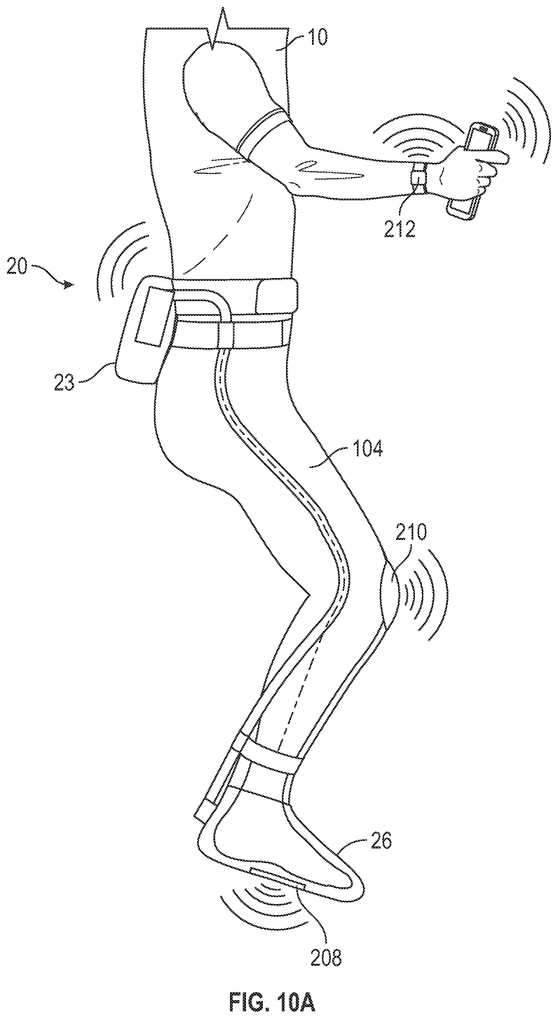

While effective joint actuation/joint assist is important for the overall functioning of the system. A common drawback with existing exoskeleton assist systems is the often bulky and rigid hardware that a user must wear for the system to function as intended. Therefore, much in the same way that FIGS. 1-7B integrate the ankle rotation components as seamlessly as possible into the article footwear 26, FIGS. 8A-9B illustrate embodiments that rely on cabling and a user's own apparel instead of requiring a rigid external structure. In doing so, the present system proves to be both lightweight and simple for the user to put on.

As generally illustrated in FIGS. 8A and 8B, in an effort to minimize the amount of distal mass that the user must translate with their legs during a stride, the motor/actuator 24 may be positioned generally on the user's torso 100 where its presence is the least noticeable by the user 10. In a preferred configuration, the motor/actuator 24 may be located at or near the user's waist 102, and may further be integrated into or readily coupled with a belt or waistband of the user's pants 104.

Due to the physical separation between the motor/actuator 24 and the user's feet 22, however, an intermediate mechanism is required to transmit any force generated by the motor to the user's shoe 26 where it provides the ambulatory assist. As shown in FIGS. 8A and 8B, and further discussed above, this mechanism can take the form of one or more intermediate cables 28 that are mechanically linked to and between the motor/actuator 24 and the article of footwear 26. Cables, such as Bowden-style cables have the ability to transmit relatively large forces at a comparatively low weight. While in most embodiments, the linear movement of the inner cable 92 relative to the outer housing 94 in a Bowden-style cable is used to transmit a pulling/tensile force, push/pull-style Bowden cables also exist and may be used with various embodiments of the present system.

In an effort to provide a sleek visual aesthetic while minimizing the existence of loose cables around the user 10, the present system may directly integrate the Bowden-style cables into an article of clothing such as into compression pants 104 as shown in FIGS. 8A-9B. In this embodiment, and with a waist-mounted motor 24, the cables 28 may exit the motor/actuator 24 near the user's waist 102 and extend down the outer/lateral side 106 of the user's legs 108. While on the outer/lateral side 106 of the user's legs 108, the cable 28 may be generally aligned with a neutral axis 110 of the leg 108 so that it neither restricts nor interferes with the user 10 bending their knee 112. Distal to the user's knee 112, the cable 28 may transition to a posterior position 116 relative to the user's leg 108. In this relative position, the cable 28 may ultimately exit the pants 104 at/from an ankle cuff 118 before being coupled to the cable connector 50 on the article of footwear 26.

In one configuration, the above-referenced Bowden-style cables may extend through one or more lumens formed in the fabric of the pants 104. Such a lumen, for example may occur at the seam of two adjoining panels of material. In another embodiment, to promote an case of laundering the pants 104, the Bowden-style cables may be detachably coupled to the pants 104, such as by slidably entering the lumen, or else being secured in place using hook and loop fasters, zippers, or the like.

As generally illustrated in FIGS. 9A and 9B, in one configuration, the outer housing 94 of the Bowden-style cables may be attached to an ankle cuff 118, which may support it during operation. In general, the friction and compression of the pants 104 and cuff 118 about the user's leg 108 and waist 102 provides a relatively stable structure against which the system can assertively pull on the user's shoe 26. Furthermore, this is a lighter weight solution than a traditional exoskeleton, while being less obtrusive or noticeable to the wearer and reducing the need for the user to don much more than a pair of pants (i.e., instead of needing to separately don a powered exoskeleton).

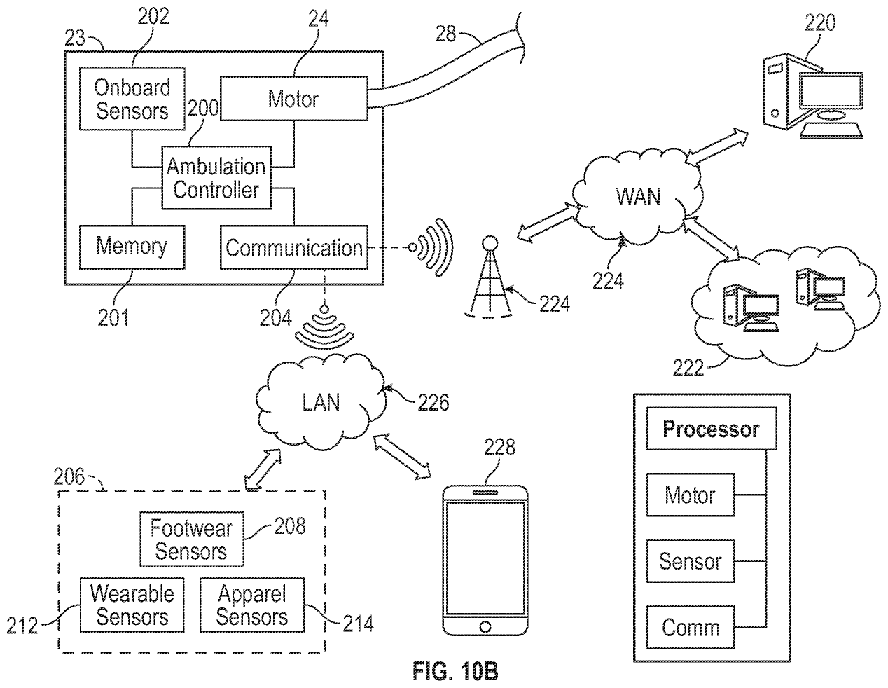

When controlling the actuation of the ambulatory assist device 20, the ambulatory engine 23 may attempt to time actuation of the user's foot 22 with the natural push off motion during the user's gait. To accomplish this, it is preferable for the device 20 to understand the user's posture, gross motion, limb position, and/or foot contact force, in real time or near-real time, so that the motor 24 can supply the assistive force at an instant that is assistive and not disruptive to the user's gait. As shown in FIGS. 10A and 10B, to gain this awareness, the ambulatory engine 23 may be or otherwise include an integrated electronics package having an ambulation controller 200, the motor/actuator 24, one or more on-board sensors 202, and communications circuitry 204.

The communications circuitry 204 may be in wireless communication with one or more remote sensors 206 disposed on the user's body. As will be discussed below, these remote sensors 206 may be configured to sense/monitor one or more biomechanical or biometric parameters of the user, and may provide this data to the controller 200 for the purpose of understanding the motion or pose or activity level of the user 10. As generally illustrated, the remote sensors 206 may include, for example, one or more accelerometers, inertial measurement units, gyroscopes, strain gauges, or force/pressure sensors connected to or embedded in the user's shoe 26, clothing, and/or on user-mounted wearable electronic devices (i.e., generally referred to as “footwear sensors 208”, “apparel sensors 210”, and “wearable device sensors 212”). Additionally, the communication circuitry 204 may be in bidirectional communication with a remote host system 220 or a cloud computing system 222 via a wireless communications network 224 (e.g., a wide area network (WAN) that includes any suitable infrastructure or computing devices that may be required to communicate over longer distances.

The host system 220 may be implemented as a high-speed server computing device or a mainframe computer capable of handling bulk data processing and/or for storing user data, user parameters, and/or user configurations for use with or by the ambulatory engine 23. In some embodiments, the host system 220 may operate as the host in a client-server interface for conducting any necessary data exchanges and communications with one or more “third party” servers to complete one or more transactions or data exchanges. The cloud computing system 222, on the other hand, may operate as middleware for IoT (Internet of Things), WoT (Web of Things), Internet of Adaptive Apparel and Footwear (IoAAF), and/or M2M (machine-to-machine) services, connecting an assortment of heterogeneous electronic devices with a service-oriented architecture (SOA) via a data network. As an example, cloud computing system 222 may be implemented as a middleware node to provide different functions for dynamically onboarding heterogeneous devices, multiplexing data from each of these devices, and routing the data through reconfigurable processing logic for processing and transmission to one or more destination applications. Network 224 may be any available type of network, including a combination of public distributed computing networks (e.g., Internet) and secured private networks (e.g., local area network, wide area network, virtual private network). It may also include wireless and wireline transmission systems (e.g., satellite, cellular network, terrestrial networks, etc.). In at least some aspects, most if not all data transaction functions carried out by the ambulatory engine 23 may be conducted over a wireless network, such as a wireless local area network (WLAN) or cellular data network, to ensure freedom of movement of the user 10.

The ambulation controller 200 and associated motion sensors 202, 208, 210, and/or 212 may attempt to model and/or understand the dynamics and/or kinematics of the user 10 to discern when the user is walking or running, and when the user's foot 22 is about to enter a push off phase of the gait. The ambulation controller 200 may include any one or various combinations of: a logic circuit, a dedicated control module, an electronic control unit, a processor, an application specific integrated circuit, or any suitable integrated circuit device, whether resident, remote or a combination of both. By way of example, the ambulation controller 200 may include a plurality of microprocessors including a master processor, a slave processor, and a secondary or parallel processor. Controller 200, as used herein, may comprise any combination of hardware, software, and/or firmware disposed inside and/or outside of the structure of the ambulation engine 23 (e.g., within a memory device 201), and may be configured to communicate with and/or control the transfer of data between the ambulation engine 23 and a bus, computer, processor, device, service, and/or network. The ambulation controller 200 is generally operable to execute any or all of the various computer program products, software, applications, algorithms, methods and/or other processes disclosed herein. Routines may be executed in real-time, continuously, systematically, sporadically and/or at regular intervals, for example, each 100 microseconds, 3.125, 6.25, 12.5, 25 and 100 milliseconds, etc., during ongoing use or operation of the controller 200.

The ambulation controller 200 may include or may communicate with a resident or remote memory device, such as a resident memory 201 that is packaged inside the s ambulation engine 23. Resident memory may comprise semiconductor memory, including volatile memory (e.g., a random-access memory (RAM) or multiple RAM) and non-volatile memory (e.g., read only memory (ROM) or an EEPROM), magnetic-disk storage media, optical storage media, flash memory, etc. A resident power supply, such as a lithium ion battery with plug-in or cable-free (induction or resonance) rechargeable capabilities, may be embedded within the ambulation engine 23.

The communications circuitry 204 may provide both long-range communication capabilities (e.g., for communication over the network 224) and/or close-range communication capabilities for communication with the more locally present remote sensors 206. Long-range communication capabilities with remote networked devices may be provided via one or more or all of a cellular network chipset/component, a satellite service chipset/component, or a wireless modem or chipset/component. Close-range wireless connectivity may be provided via a BLUETOOTH® transceiver, a radio-frequency identification (RFID) tag, an NFC device, a DSRC component, and/or a radio antenna. Wireless communications may be further facilitated through implementation of a BLUETOOTH Low Energy (BLE), category (CAT) M1 or CAT-NB1 wireless interface.

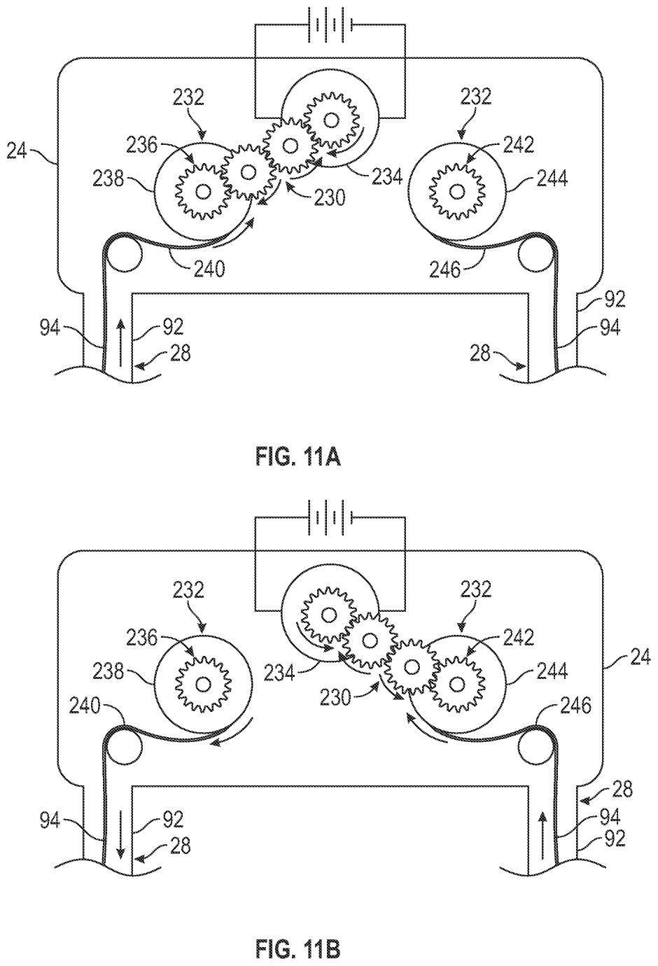

The motor/actuator 24 may include any suitable electromechanical actuator for applying a tension to an attached cable 28. Suitable motors may include brushless or brushed motors, stepper motors, servomotors, linear motors, and the like. To facilitate linear tensioning of the cable 28, additional mechanisms may be coupled with the motor including gear trains, ball screws, lead screws, spools, pulleys, and the like. In one configuration, such as shown in FIGS. 11A-11B, the motor 24 may include an articulating gear train 230 that is configured to only drive one coupled spooling device 232 at a time. As shown in FIG. 11A, when the electric motor 234 drives the articulating gear train 230 in a first direction, it may rotate into contact with a first driveable gear 236 to thus rotate a first spool 238 and tension a first cable 240. As illustrated in FIG. 11B, when the electric motor 234 drives the articulating gear train 230 in the opposing direction, the articulating gear train 230 may rotate into contact with a second driveable gear 242 to thus rotate a second spool 244 and tension a second cable 246. While the second driveable gear 242 is being acted upon by the articulating gear train 230, the first spool 238 and first cable 240 may be permitted to either freely unspool, or else may be unwound actively via an associated return spring. The same may occur with the second spool 244 and second cable 246 when the articulating gear train 230 is driving the first driveable gear 236. In this manner, a single motor may be capable of driving the mechanisms on both legs, thus resulting in a net weight savings when compared with a two motor system.

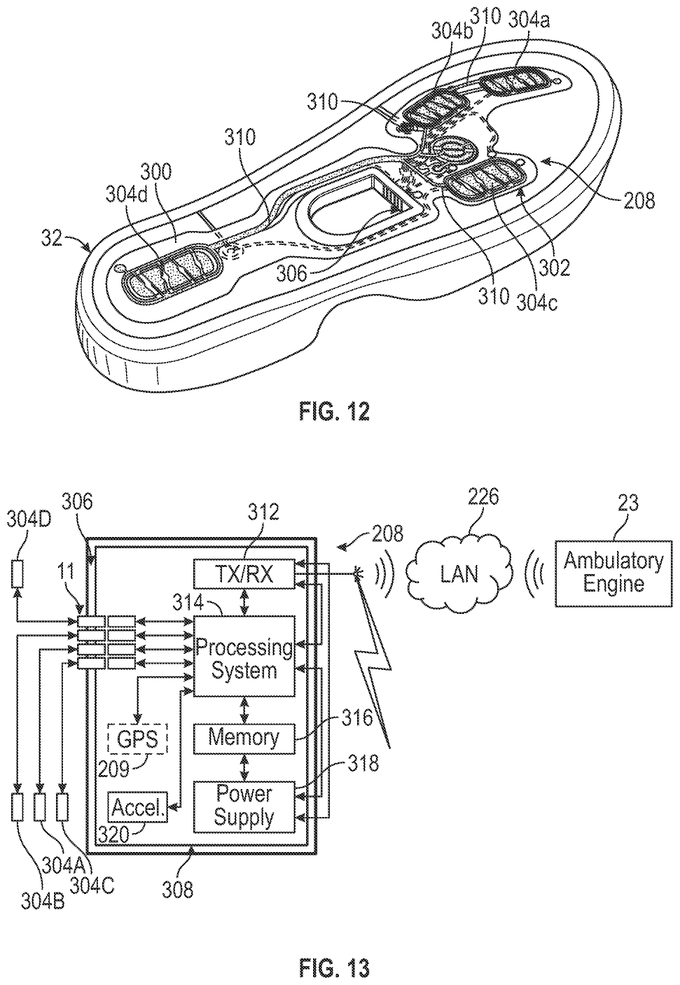

FIG. 12 illustrates one embodiment of a sole structure 32 of a shoe 26 that may include a footwear sensor 208 and associated resident circuitry for communicating data with the ambulatory engine 23. In this embodiment, the footwear sensor 208 includes an insert member 300 having a force and/or pressure sensor assembly 302 connected thereto. The insert member 300 is configured to be positioned in contact with the sole structure 32 of the footwear 26 such that it can receive a pressure input from the user's foot 22. In some embodiments, the insert member 300 may contact or may be depressed into the upper surface of the midsole 48. The sensor assembly 30 includes a plurality of sensors 304, and a communication or output port 306 in communication with the sensor assembly 302 (e.g., electrically connected via conductors). The port 306 is configured for communicating data between the sensors 304 and an electronic module (also referred to as an electronic control unit) 308 as described below. The module 308 may be configured to communicate with an external device, such as the ambulatory engine 23. In the embodiment illustrated in FIGS. 12-13, the footwear sensor 208 has four sensors: a first sensor 304a at the big toe (first phalange or hallux) area of the shoe, two sensors 304b-c at the forefoot area of the shoe, including a second sensor 304b at the first metatarsal head region and a third sensor 304c at the fifth metatarsal head region, and a fourth sensor 304d at the heel. These areas of the foot typically experience the greatest degree of pressure during movement. Each sensor 304 is configured for detecting a pressure exerted by a user's foot on the sensor 304. The sensors communicate with the port 306 through sensor leads 310, which may be wire leads and/or another electrical conductor or suitable communication medium. For example, in the embodiment of FIG. 12, the sensor leads 310 may be an electrically conductive medium that is printed on the insert member 300, such as a silver-based ink or other metallic ink, such as an ink based on copper and/or tin. The leads 310 may alternately be provided as thin wires in one embodiment.

Other embodiments of the footwear sensor 208 may contain a different number or configuration of sensors 304, and generally include at least one sensor 304. For example, in one embodiment, the footwear sensor 208 includes a much larger number of sensors, and in another embodiment, the footwear sensor 208 includes two sensors, one in the heel and one in the forefoot of the shoe 26. In addition, the sensors 304 may communicate through the port 306 to the electronic control unit 308 in a different manner, including any known type of wired or wireless communication, including Bluetooth and near-field communication. A pair of shoes may be provided with footwear sensors 208 in each shoe of the pair, and it is understood that the paired sensor systems may operate synergistically or may operate independently of each other, and that the sensor systems in each shoe may or may not communicate with each other. It is understood that the footwear sensor 208 may be provided with computer programs/algorithms to control collection and storage of data (e.g., pressure data from interaction of a user's foot with the ground or other contact surface), and that these programs/algorithms may be stored in and/or executed by the sensors 304, the module 308, and/or the ambulatory engine 23. In the embodiment illustrated in FIGS. 12-13, the sensors 304 are force and/or pressure sensors for measuring pressure and/or force on the sole 32. The sensors 304 have a resistance that decreases as pressure on the sensor 16 increases, such that measurement of the resistance through the port 306 can be performed to detect the pressure on the sensor 304.

FIG. 13 shows a schematic diagram of an example electronic module 308 including data transmission/reception capabilities via a data transmission/reception module 312. While the example structures of FIG. 13 illustrate the data transmission/reception system (TX-RX) 312 as integrated into the electronic module structure 308, those skilled in the art will appreciate that a separate component may be included as part of a footwear structure or other structure for data transmission/reception purposes and/or that the data transmission/reception system 312 need not be entirely contained in a single housing or a single package in all embodiments. Rather, if desired, various components or elements of the data transmission/reception system 312 may be separate from one another, in different housings, on different boards, and/or separately engaged with the article of footwear 26 in the sole structure 32 and/or in the upper 30.

The electronic component 308 of this example further includes a processing system 314 (e.g., one or more microprocessors), a memory system 316, and a power supply 318 (e.g., a battery or other power source). In one embodiment, the power supply 318 may be configured for inductive charging, such as by including a coil or other inductive member. In this configuration, the module 308 may be charged by placing the article of footwear 26 on an inductive pad or other inductive charger, allowing charging without removal of the module 308 from the port 306. In another embodiment, the power supply 318 may additionally or alternately be configured for charging using energy-harvesting technology, and may include a device for energy harvesting, such as a charger that charges the power supply 318 through absorption of kinetic energy due to movement of the user.

Connection to the one or more sensors can be accomplished as shown in FIG. 13, but additional sensors (not shown) may be provided to sense or provide data or information relating to a wide variety of different types of parameters, such as physical or physiological data associated with use of the article of footwear 26 or the user, including pedometer type speed and/or distance information, other speed and/or distance data sensor information, temperature, altitude, barometric pressure, humidity, GPS data, accelerometer output or data, heart rate, pulse rate, blood pressure, body temperature, EKG data, EEG data, data regarding angular orientation and changes in angular orientation (such as a gyroscope-based sensor), etc., and this data may be stored in memory 316 and/or made available, for example, for transmission by the transmission/reception system 312 to some remote location or system. The additional sensor(s), if present, may also include an accelerometer 320 (e.g., for sensing direction changes during steps, such as for pedometer type speed and/or distance information, for sensing jump height, etc.). In one embodiment, the data from the sensors 304 may be integrated with the data from the accelerometer 320, such as by the module 308 or the ambulatory engine 23.

As additional examples, electronic modules, systems, and methods of the various types described above may be used for providing automatic impact attenuation control for articles of footwear. Such systems and methods may operate, for example, like those described in U.S. Pat. No. 6,430,843, U.S. Patent Application Publication No. 2003/0009913, and U.S. Patent Application Publication No. 2004/0177531, which describe systems and methods for actively and/or dynamically controlling the impact attenuation characteristics of articles of footwear (U.S. Pat. No. 6,430,843, U.S. Patent Application Publication No. 2003/0009913, and U.S. patent application Publication No. 2004/0177531 are each entirely incorporated herein by reference and made part hereof). When used for providing speed and/or distance type information, sensing units, algorithms, and/or systems of the types described in U.S. Pat. Nos. 5,724,265, 5,955,667, 6,018,705, 6,052,654, 6,876,947 and 6,882,955 may be used. These patents each are entirely incorporated herein by reference. Additional embodiments of sensors and sensor systems, as well as articles of footwear and sole structures and members utilizing the same, are described in U.S. Patent Application Publications Nos. 2010/0063778 and 2010/0063779, which applications are incorporated by reference herein in their entireties and made part hereof.

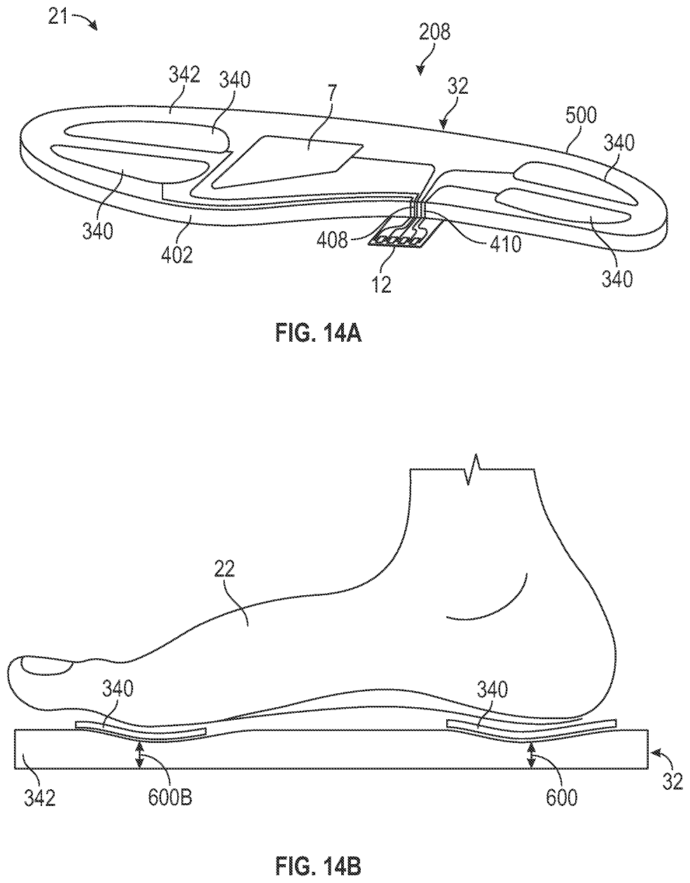

Further details of various embodiments of the footwear sensor 208 are found in U.S. Patent Application Publications Nos. 2013/0213147 and US 2021/0197021, which are both incorporated by reference in their entirety. In addition to these illustrated embodiments, footwear sensors 208 that may be used with the present ambulatory assist device 20 may include one or more flexible sensors 340 that are embedded into or otherwise affixed onto a fluid-filled cushioning device 342, such as an airbag that is integrated into the midsole 48. An embodiment of such a cushioning device 342 ia illustrated in FIGS. 14A-14B and further described in U.S. Patent Application Pub. No. 2021/0368925, which is incorporated by reference in its entirety.

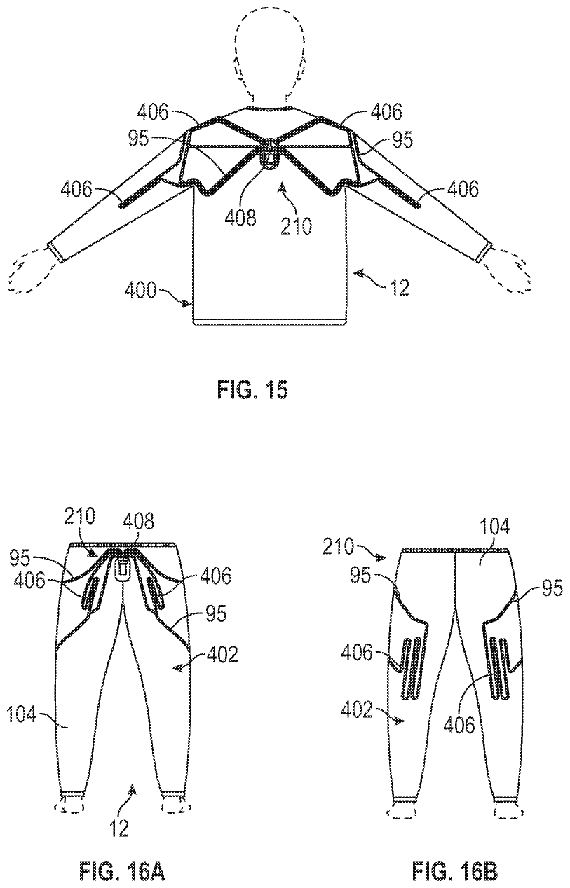

Referring again to FIG. 10, the ambulatory engine 23 may receive pressure data, accelerometer data, motion data, joint bend angle data, GPS data, biometric data (e.g., heart or respiration rate), and/or body/limb posture data from one or more apparel sensors 210 and/or from one or more wearable device sensors 212. While smart watches, rings, or fitness trackers are all examples of wearable device sensors 212 that are capable of communicating with the ambulatory engine 23, an example of an apparel sensor may include a shirt 400 or a legwear article 402 (e.g. compression pants 104) that includes a sensor system 404 for sensing force, movement, and/or other biomechanical parameters, as shown in FIGS. 15-16B. As generally illustrated, the shirt 400 and legwear 402 in these embodiments may include sensors 406 at joint areas that are in communication with a control module 408. The control module 408 may be operative to collect data from the sensors 406 that reflects one or more biomechanical parameters. The module 406 may collect various forms of data and communicate it to an ambulatory engine 23, as similarly described above.

The ambulation controller 200 may receive the data from the various sensors 208, 210, 212 and analyze it to better understand the user's current biomechanical movement pattern, physical state, level of fatigue and present surroundings. From this analysis the ambulation controller 200 may determine the appropriate amount and timing of the provided assistance to satisfy the user's preset goals, improve the user's form during an activity, or aid the user in training.

In addition to being used for ambulatory assist purposes, the data collected by the controller 200 can be used in measurement of a variety of other athletic performance characteristics. For example, the data can be used to measure the degree and/or speed of foot pronation/supination, foot strike patterns, balance, and other such parameters, which can be subsequently used to provide guidance or technique suggestions to the user, improve technique in running/jogging or other athletic activities. Similarly, speed and distance monitoring can be performed, which may include pedometer-based measurements, such as contact measurement or loft time measurement. Jump height can also be measured, such as by using contact or loft time measurement. Lateral cutting force can be measured, including differential forces applied to different parts of the shoe 100 during cutting. The sensors can also be positioned to measure shearing forces, such as a foot slipping laterally within the shoe 26. As one example, additional sensors may be incorporated into the sides of the upper 30 of the shoe 26 to sense forces against the sides.

For the purpose of receiving user inputs and for providing feedback to the user, in some embodiments, the ambulatory engine 23 may be in bidirectional communication with a mobile device 228, such as a smart phone. In some embodiments, the data, or the measurements derived from the sensor data may be presented to the user via the display provided on the mobile device 228. This data may be useful for athletic training purposes, including improving speed, power, quickness, consistency, technique, and for providing the user with active, real-time feedback. The mobile device 228 may further be configured to serve as an input device for the controller 200 via the display and a suitable digitizer/input means. In some embodiments, the user may use the mobile device to input one or more training goals, target parameters, or other such training profiles or biomechanical movement patterns that may control the degree of assist provided by the device 20.

In some configurations, the ambulatory engine 23 may also be capable of providing the user with real time feedback via the inclusion of one or more vibration/haptic elements in the shoe 26. In other embodiments, the ambulatory engine 23 may provide real time feedback by dithering the tension applied through the cable 28 with a low-magnitude oscillating tension provided at a periodic frequency. Either way, this haptic response capability may enable the ambulatory engine 23 to provide a user with feedback to alert the user to a deviation in speed, pace, or form from an expected profile, to provide an alert about dangerous conditions or approaching vehicles, or to provide navigation directions. Similar haptic feedback features are disclosed in U.S. Pat. Nos. 6,978,684 and 11,553,754, both of which are incorporated herein by reference in their entirety and for all that they disclose.

In one configuration, the ambulatory controller 200 is configured to analyze the data that is received from the sensors 206 to determine whether any derived biomechanical movement pattern deviates from a desired biomechanical movement pattern. If a deviation exists, and if the deviation is of the kind that can be corrected or adjusted via the ambulatory assist device 20, then the ambulatory controller 200 may operate the motor 24 in such a manner to provide the assist to the user and correct the movement pattern deviation. Furthermore, in some embodiments, the ambulatory controller 200 may generate an indication to the user when deviation from the desired biomechanical movement pattern is determined to exist, which may be provided to the user via a suitable mobile device 228 or haptic controller. A deviation from a desired biomechanical movement pattern may be determined, through the use of a biomechanical movement template, which may be stored in the memory of the ambulatory engine 23. Deviation from the template may indicate deviation from the desired biomechanical movement pattern. It is understood that the determination of “deviation” may include threshold variations, where the data is not considered to deviate from the template unless the threshold is exceeded.

Movement templates may be obtained in a variety of ways. As one example, a template may be included in software applications stored in the memory of the ambulatory engine 23 and/or obtained from other tangible storage media. As another example, a template may be accessed by communication with another electronic device, such as a download over the internet or other network. As a further example, a template may be created by the user, by either selecting a desired movement pattern or recording an actual movement pattern of the user or another person. It is understood that any such templates may be stored in the memory.

Examples of biomechanical movement templates that may be used in connection with embodiments of the system include various footstrike and other running templates, such as templates for footstrike pattern, footstrike load or force, gait speed, stride length, footstrike contact time, speed, distance, footstrike cadence, pronation/supination, stride force, upper body movement, lean, asymmetry, posture, and others. Data gathered by a sensor incorporated within an article of footwear 26 may be compared with one or more of these templates. Additional examples of biomechanical movement templates that may be used in connection with embodiments of the system include templates for: running form, throwing form (which may be tailored to a specific activity such as baseball, football, softball, cricket, etc.), basketball shooting form, swing form (which may be tailored to a specific activity such as baseball, golf, tennis, hockey, etc.), kicking form (e.g. for soccer or football), ice skating or roller skating form, jumping form, climbing form, weightlifting or other stationary exercise form, posture, and many other templates corresponding to many other biomechanical movement patterns. Templates may be created based on a number of different subjects, including a preferred or “proper” biomechanical movement pattern (such as with input of coaches, trainers, sports medicine professionals, etc.), a past biomechanical movement pattern of the user, a biomechanical movement pattern of a famous athlete or other famous person, etc.

In one embodiment, a method for providing an ambulatory assist to a user via an ambulatory assist device 20 such as shown in at least FIGS. 1-10B may begin with the ambulatory assist device 20 being donned by the user 10. In some instances, this may include donning a pair of compression pants 104 having an integrated Bowden cable 28 and ambulatory engine 23, donning a pair of athletic shoes 26, and coupling the Bowden cable 28 of the compression pants 104 with a suitable cable connector 50 on the shoes 26. Once being donned, the various footwear sensors 208, apparel sensors 210, and/or wearable sensors 212 may begin transmitting data to the ambulatory engine 23. In one embodiment, the ambulatory engine 23 may receive data from the various sensors 208, 210, 212 in real time and/or in a substantially continuous manner, which may be accomplished by periodic transmission of individual data units or packets of data in various embodiments. In other embodiments, the ambulatory engine 23 may receive collected past data incrementally or in a single transmission.

The controller 200 of the ambulatory engine 23 may then analyze the data to determine whether the user is in motion, is taking regular and predictable strides, and/or whether the user's movement deviates from an expected or desired biomechanical movement pattern. In one configuration, the controller 200 may determine whether a deviation from an expected or desired pattern exists by comparing the received data to one or more templates that have been selected. If a deviation from an expected or desired movement pattern is detected, then the controller 200 may energize the motor/actuator 24 for the purpose of selectively tensioning the Bowden cables 28 and applying a resulting torque to the user's foot/ankle. The timing of the applied motor actuation may coincide with any part of the user's gait depending on the nature of the deviation, however in the most likely case, the motor may tension the corresponding Bowden cable 28 when a pressure is sensed between the user's forefoot and the sole structure 32, a pressure between the user's heel and sole structure 32 is decreasing toward zero, and the user is globally moving along the terrain.

In some embodiments, the controller 200 may further include the nature of the terrain into its determination of whether and when to apply a torque to the user's foot/ankle 22. For example, the controller 200 may include software that adapts or alters the expected or desired biomechanical movement patterns based on position information received from an onboard GPS module in combination with environmental information and/or terrain information. In such an example, if a user were running on an incline, the controller 200 may adapt the expected foot strike pattern and duration to provide a potentially longer or shorter time of applied torque and/or may initiate the onset of the torque at a different threshold heel pressure than it would otherwise use on flat ground. It may also assume a longer duration foot strike, as stride length may decrease when, for example, running uphill.

During a particular activity, a user may periodically receive indications and/or alerts from the ambulatory engine 23, e.g., by the ambulatory engine 23 transmitting a signal to a second electronic device, such as an mobile device 228 held by the user during the activity. The indications may notify a user when the assistive torque is being altered or changed relative to a nominal baseline or if the user's contribution to the overall ambulation falls below a predetermined threshold percentage. The indications and alerts may be visual, audible, and/or tactile/haptic (via the mobile device or via a haptic motor in the user's shoes or through a dithering of the tension in a cable) depending on the electronic device capabilities and/or a user selection. For example, in some embodiments, the indications and alerts may provide specific coaching guidelines to a user during an athletic activity

Upon completion of the athletic activity session, the system may provide feedback to the user based on data recorded during the activity and the amount of assistive torque or effort that was applied to the user. In some embodiments, the feedback may include an activity report for a subsequent athletic activity session, e.g., a suggested distance and speed for a next run to achieve an optimal training plan. The feedback may also include a stretching activity following the athletic activity session based on the nature and duration of the activity and the specific motions that were assisted. The suggested stretching exercises may include calf stretching and strengthening in addition to stretching and strengthening the foot. The system may also prompt a user for input relating to a perceived discomfort during an athletic activity which may include a level of discomfort and/or specifying a general area of discomfort (the arch, the heel, the calf, and the like). Accordingly, the perceived discomfort input may affect the feedback reported to the user. Over the duration of the use of the device 20, controller 200 may be configured to record a plurality of athletic activities for a particular user. Recorded parameters may include, for example, a number of athletic activities, a total time and/or distance of recorded data as provided by positional data from the GPS module, an amount of assist per activity, and/or a percentage of user effort relative to total expended (device+user) effort.

In another embodiment, the ambulatory engine 23 and associated software may provide the ability for a user to review performance metrics from a previous activity and identify areas of success and/or areas that need improvement. This feature may be incorporated into the creation of the “ideal” activity described above, and may provide the ability for the user to modify certain aspects of the template(s) for the “ideal” activity. Additionally, the recordation of past performance metrics can enable the user to track performance, improvement, trends, progress, etc., over time, and the device may provide such past data for access and review. Likewise, the user may be able to manually control the amount of assist for subsequent activities after reviewing the amount of assist and total effort from past activities. Types of information tracked by the ambulatory engine 23 may include degree of success with compliance to various templates as well as additional information including, without limitation, speed, distance, steps or repetitions, energy used, jump height/distance, stride length, and any other information mentioned elsewhere herein. Recorded data from an activity may be uploaded from the ambulatory engine 23 to another device, such as through “sync” procedures used in the art. One or more devices can thereby record accumulated performance metric data for a number of different activities over time, and further processing and refining can be performed to present such data in a form that is easy for the user to review. In one embodiment, recorded data and/or analyzed data may be uploaded to a remote server/website for access through a webpage, and may additionally be shared with an online “community,” where users can compare progress and activity with other users. The online community may have filtering capabilities as well, for example, to permit the user to compare information with others having similar physical build, activity level, age, etc. The online community may also have “challenge” capabilities to allow one user to challenge another user in achieving an accomplishment, such as more consistently conforming to a biomechanical movement template. Data and other information obtained from the user may also be used in a social networking context as described below, and it is understood that the social networking may be integrated with or otherwise associated with the online community. Further, devices 110 used in connection with such performance metrics can form a detailed user profile that includes performance data, as well as relevant personal and other information, in one embodiment. Such a user profile may also be used for an online community as described above and/or for social networking, as described below. As more data is collected, the device(s) can offer more closely customized data presentations, analysis, and suggestions or indications for improvement.

In one embodiment, the device and associated software may provide one or more data entry screens for the user to enter personal data that can be used to build the user profile. For example, the user may be prompted to enter physical data that may influence system performance and template selection, such as age, gender, height, weight, etc. As another example, the user may be prompted to enter identifying information, such as name, birthdate, login information (e.g. username and password), etc. As a further example, the user may be prompted to enter preference information, such as interests, terrain and/or environmental preferences as described above, color and layout preferences, and general software functionality preferences, including feedback preferences such as the form(s) of the indications of success/failure, what data is collected, analyzed, and/or displayed, and other functionality preferences. As yet another example, the user may be prompted to enter data regarding a planned future activity that will utilize the device 20, such as the length and intensity of the activity, specific goals of the activity, desired functionality of the device 20 for the activity, and other such information.

In another embodiment, the device and associated software may provide safety features that are activated when the device senses an accident (e.g. a fall) based on data received from the various sensors 208, 210, 212. For example, the ambulatory engine 23 may detect a fall or other major discontinuity in data and may prompt the user to confirm whether a safety or health issue exists. If the user indicates that an issue exists, or if no response is received in a set time period, the ambulatory engine 23 may contact emergency responders, such as by phone call, SMS, email, or other means. Depending on the capability of various sensors, the ambulatory engine 23 may also be able to relay information such as respiration, heart rate, temperature, etc.

In another embodiment, the device and associated software may be used in connection with social networking applications. For example, performance metric data may be compared with data from other social networking contacts. As another example, collected performance metric data may be translated into “points” or “credits” for social networking games, where the user is able to modify or further play such games using such points or credits. This can provide an additional source of encouragement to the user for reaching performance and exercise goals. Additional manners of acquiring, managing, and analyzing sensed user motion, which may serve as the basis for dynamically adjusting the timing and intensity of the assistive ambulatory response can be found in US Patent Application Pub. No. 2021/0197021, which is incorporated by reference in its entirety and for all that it discloses.

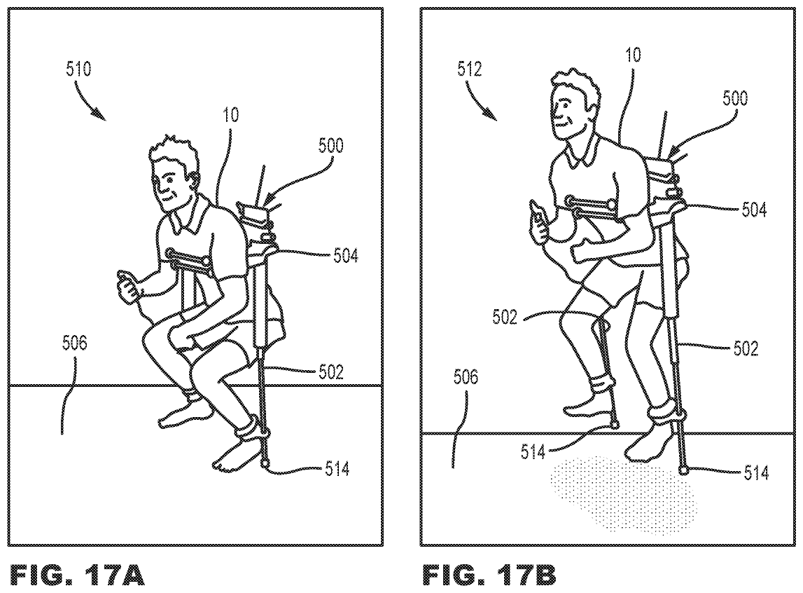

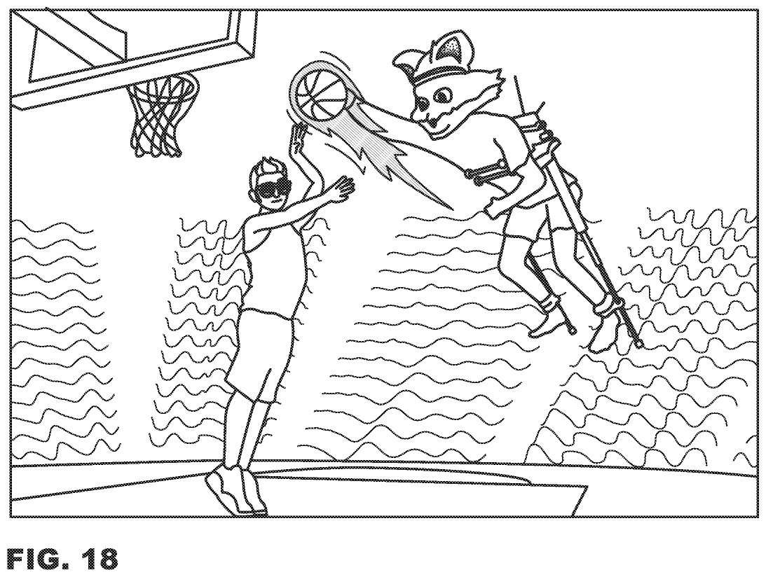

While the preceding disclosure has focused largely on assisting a user with walking or running, in some embodiments, similar assistive devices may be used to enhance a user's jumping motion, such as generally illustrated in FIGS. 17A-18. In this embodiment, a jump assist device 500 may include one or more linear (pogo-stick-like) actuators 502 that extend down from a control pack 504 that is worn on the user's back or waist. When actuated, the linear actuators 502 may contact and exert force against the ground 506 for the purpose of adding additional energy to a user's jump. This embodiment, may rely on similar sensory feedback and techniques as the ambulatory assist device 20, however it may rely on different expected or desired biomechanical movement patterns to gauge the appropriate time to initiate the assistive jump and to what degree.

In some embodiments, the linear actuators 502 may be pneumatic actuators that extend outward beyond the sole of the user's shoes in response to the control pack 504 expelling a controlled pressurized gas or fluid charge into the actuator 502. FIG. 17A generally illustrates the jump assist device 500 in a “loaded” state 510, while FIG. 17B illustrates the jump assist device 500 in an “assistive” state 512. In the loaded state 510, the distal ends 514 of the actuators 502 are flush with the ground-contacting surface of the user's shoes.

As the user initiates their jump, the control pack 504 may receive sensory data from one or more footwear sensors 208, apparel sensors 210, wearable sensors 212, or onboard sensors to determine a movement pattern that often precedes a jump, followed by the beginnings of an upward weight transfer and then the decrease of a heel pressure. Upon sensing the appropriate movement patterns, the control pack 504 may release the gas charge into a pneumatic cylinder, which extends the actuators beyond the soles, such as shown in FIG. 17B. In some embodiments, the actuator 502 may be physically separated from control pack 504, though may include one or more high pressure air lines that extend between the pack 504 and the actuator 502. For example, in one configuration, the pneumatic actuator portion of the linear actuator 502 may be coupled to the user's lower leg 516 and may be in fluid communication with the control pack 504 via an intermediate air conduit. FIG. 18 schematically illustrates a user 10 after they have triggered the assistive jumping device 500 of FIGS. 17A and 17B. As shown, the jump assist device 500 has sent the user soaring to new heights while bringing joy to everyone (except probably the defender 516 who doesn't have a jump assist device of his own).

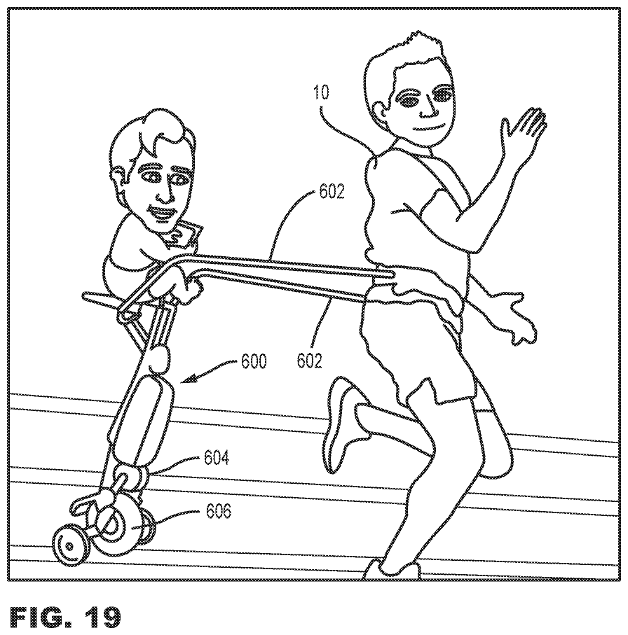

While the prior examples have all focused on wearable assist devices, in some embodiments, the assist device may be an external assist device such as shown in FIGS. 19-21. These embodiments include a powered follower device 600 (i.e., the “follower 600”) that is interconnected with the user 10 via one or more straps, bars, or other such interconnecting linkages 602. The follower 600 may include a motor 604 that powers at least one drive wheel 606 for the purpose of propulsion.

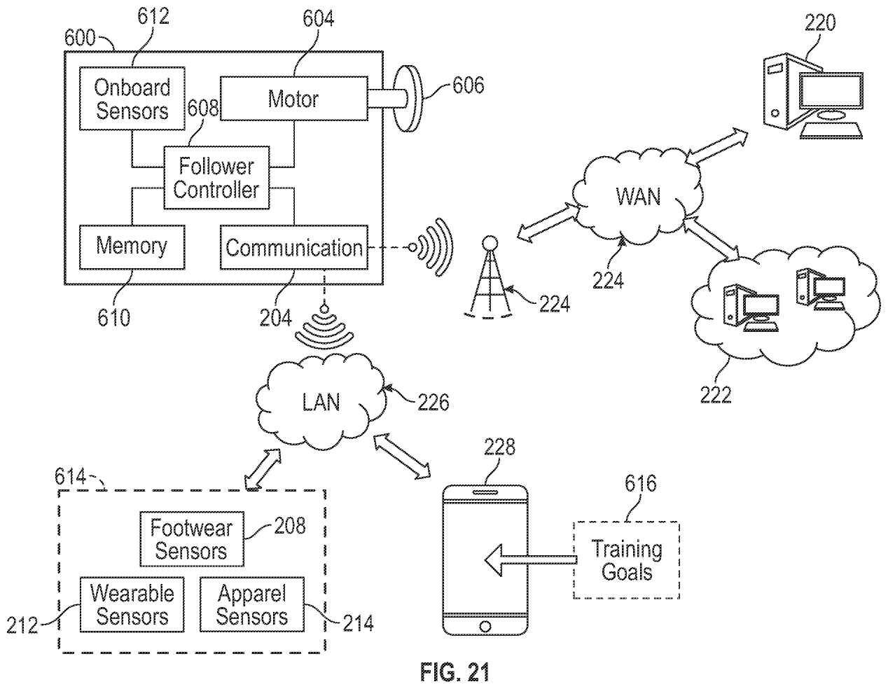

Much like the ambulatory assist device 20 that is schematically illustrated in FIG. 10B, in some embodiments, such as shown in FIG. 21, the follower 600 may include a controller 608 that is in communication with the motor 604, memory 610, communication circuitry 204, one or more local sensor systems 612, one or more remote sensor systems 614. The local sensor system 612 may include, for example, one or more accelerometers, rotational sensors attached to the drive wheel 606, inertial measurement units, GPS units, load sensors configured to monitor an approximate mass of the follower 600 and/or cargo supported by the follower 600, load sensors configured to monitor a force applied by or to the user, and/or gyroscopic sensors. The one or more remote sensor systems 614 may include, for example, footwear sensors 208, apparel sensors 210, and/or wearable sensors 212, such as described above.

In general, the controller 608 may drive the motor 604 and coupled drive wheel 606 on the basis of at least the data received by the local sensor systems 612 and/or remote sensor systems 614. In some embodiments, the controller 608 may execute software code stored in the associated memory 610 that drives the motor 604 with the specific purpose of applying a defined amount of resistance or assistance to the user 10 during the user's ambulatory motion (i.e., the net applied force). For the sake of clarity, a negative net force may be viewed as a resistive force and a positive net force may represent an assistive force.

In one configuration, the net applied force may have a magnitude that attempts to track a target net applied force. In some embodiments, the target net applied force may be set directly, such as by inputting a predefined resistance/assistance value, curve, or step function. In other embodiments, however, the target net applied force may vary as a function of one or more training goals 616, environmental factors, sensed biomechanical factors, and/or sensed biometric factors. For example, a method of controlling the follower may begin by a user inputting one or more training goals 616 into a user device 228 that is in digital communication with the follower 600. Either the user device 228 or the controller 608 may develop a training plan to satisfy the target goals based on one or more discrete training sessions (i.e., each training session may have a session plan, and a longer course of training may have multiple session plans that deviate day-to-day based on prior strain, rest, and recovery.

During a given training session, the controller 608 may monitor the one or more local sensor systems 612 and/or the one or more remote sensor systems 614 to determine the user's instantaneous performance relative to the plan. In some embodiments, the plan may be defined by a target energy output by the user, or by a target heart rate, or simply by a target resistance in a high intensity interval training manner. Throughout the training session, the controller 608 may dynamically adjust the session plan according to the user's real time biomechanical performance and/or biometric parameters. For example, if a user is struggling to achieve the goals that were set out, and is over exerting as a result, the controller 608 may adjust the goals downward for that session to maintain the user in an optimal training state that minimizes the chance for injury. During the control of the drive wheel 606, the target net applied force may be a dependent variable in a control scheme that attempts to follow the established (and possibly dynamically modified) session plan.

In one particular embodiment, the controller 608 may develop a session plan that attempts to maximize a particular calorie burn. In doing so, the device 228 or controller 608 may develop a session plan characterized by a predefined resistance curve, where certain periods of time may have a first negative net applied force and may be characterized as being intensely resistive similar to pulling a weighted sled. Other periods of time may have a second negative net applied force that is greater than the first negative net applied force (i.e., greater in the sense that it is less negative/resistive) and may be characterized as being mildly resistive similar to running up a moderate incline. Still other periods of time may have a third positive net applied force and may be characterized as a recovery phase. During the workout, the controller 608 may monitor the biomechanical performance and/or biometric parameters of the user and may dynamically alter the profile of the target net applied force on the basis of this feedback. For example, if the user's heart rate exceeds a desired threshold, or the user's foot strike pattern deviates from a desired foot strike pattern, or the user's gait unexpectedly shortens, then the controller may decrease the amount of resistive force applied via the follower 600. Likewise, in some embodiments, the controller 608 may alter the profile of the target net force in an effort to maintain a sensed parameter within a predefined range or on a predefined profile. For example, the controller 608 may generally follow the interval-type resistance profile, though may adjust the specific resistances to encourage the user's heart rate to follow a predefined curve or stay within a predefined band.

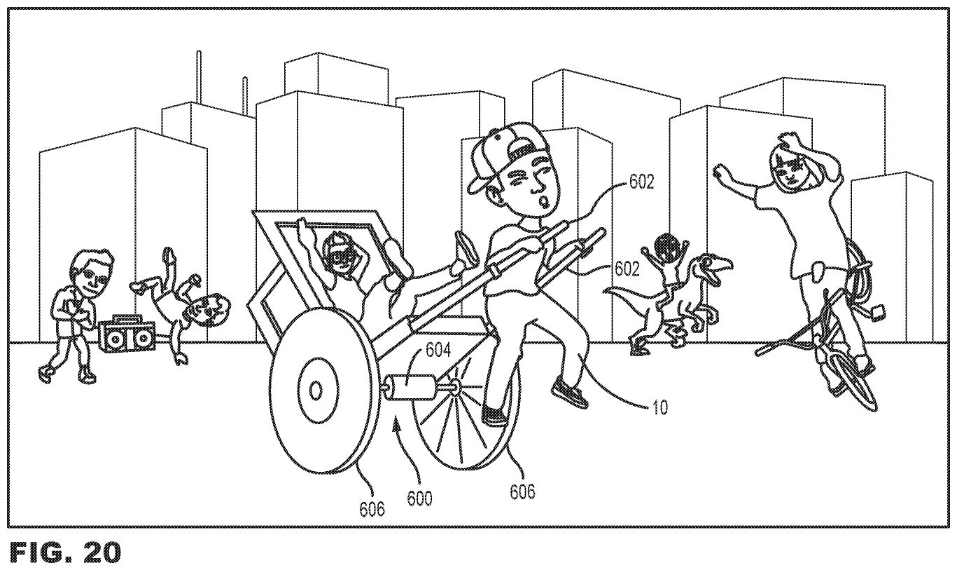

In some embodiments, the follower 600 may also be configured to adaptively adjust the torque output to compensate for the weight of the follower 600 (and any cargo/passengers). As shown in FIG. 19, this dynamic load compensation may permit a user to train while spending time with their children (much like pulling a carrier behind a bicycle). As shown in FIG. 20, this dynamic adjustment may also permit a user to pull a heavy load (e.g. like passengers on a rickshaw) for longer periods than they would otherwise be capable of doing.

In still another embodiment, the follower 600 may be configured to apply a strongly resistive force if it senses that continued motion by the user 10 would place the user 10 in a dangerous situation. For example, in some embodiments, the controller 608 may include communication capabilities that enable it to identify the presence of one or more approaching vehicles. This awareness may enable the controller 608 to take remedial action/prophylactic measure to prevent a collision via one or more alerts or resistive forces applied via the drive wheel 606. For example, the controller 608 may be part of, or in wireless communication with an Internet of Adaptive Apparel and Footwear (IoAAF) system such as described in U.S. Patent Application Pub. No. US 2019/0365014, which is incorporated by reference in its entirety and for all that it discloses. Unlike the '014 application, however, the present follower system may have the ability to stop or greatly limit a user's forward motion before a collision may occur.

In a general sense, any/all of the assistive devices 20, 400, 600 described herein may be components in broader digital ecosystem that rewards movement and physical activity. For example, in one configuration, motion and usage data that is recorded from an assistive device 20, 400, 600 may serve as a mechanism or trigger for the distribution of certain rewards. These rewards may include, without limitation: the distribution of one or more digital collectables; unique access to receive or purchase one or more digital or physical items; the evolution of an owned or linked digital collectable; and/or digital credits that can be redeemable for digital collectables, physical items, access, and/or future discounts on the purchase of digital and/or physical items.

As an example of such a reward system, in one configuration, the user's motion and or usage data may be uploaded from the device 20, 400, 600 (either directly, or via a linked computing device/smartphone) to a user account on a remote computing device. In some embodiments, the remote computing device may convert the motion and usage data into a score (e.g., a plurality of “points”) that may be aggregated by the user over a plurality of training sessions or uses. This conversion into points may account for various factors, such as usage time, total distance, total number of steps, expended user effort, and/or user growth from an initial baseline. Once a user's aggregated point total exceeds a threshold, the user may have one or more digital experiences or opportunities made available to claim. Alternatively, the aggregated point total may automatically initiate one or more changes in digital assets/collectibles associated with the user's account. In some embodiments, these changes may be irreversible evolutionary changes in design, color, size, appearance, or functionality of the digital collectable. In other embodiments, the changes may be temporary changes that are either directly applied to the digital collectible or made available to the user for the user to subsequently apply to the digital collectible. Such after-applied changes may be similar to skins that the user can earn and then apply, for example, to a character, avatar, or object within a virtual environment or video game.

In one particular embodiment, the motion and biometric data collected by the ambulatory assist device can be used to generate unique inputs that trigger distribution and modification of digital collectibles linked to the user's account. For example, the user may connect the device to a mobile app operating on a portable computing device 228 or to an internet connected remote host or cloud computing system. As the user walks or exercises, the device may track metrics such as, for example, steps, distance, heart rate, and/or calories. These metrics may then be uploaded to the connected computing device, where they may be converted into “fitness coins” or “energy tokens” according to a predefined conversion formula. In some embodiments, these “coins” or “tokens” may be unique blockchain-registered assets that are generated directly in response to the user's activity in the aggregate or for that particular session.

After each session, the newly generated coins or tokens may be added to a tally or collection of coins/tokes in the user's account. From here, the user may then use or “spend” the coins/tokens in various ways, such as to secure product discounts, gain exclusive access to physical or digital product releases, or to use within a crypto-enabled fitness community or metaverse. For example, in a crypto-type usage, the user may have a collection of digitally unique character avatars, digital collectables, or character NFTs that live/exist in an exercise-based metaverse. As the user accrues more fitness coins, the user can use/spend these tokens to “feed” or care for their character NFT/avatar/digital collectable. This care and feeding may cause the character NFT/avatar/digital collectable to gain experience points, evolve, and/or gain new abilities or features over time. In some embodiments, rarer character NFTs require more fitness coins to evolve, which may create an engaging gameplay loop where more activity grants access to more exclusive digital content. In other embodiments, fitness coins could be used/spent to unlock NFTs/digital collectables resembling articles of customizable apparel or footwear that may be used or worn by the user's metaverse avatar. Such articles of customizable apparel or footwear may include shoes, shirts, hats, accessories, or footwear that reflect the user's personal style and progress. In this manner, the ambulatory assist device and fitness metaverse combine to transform exercise into tangible digital ownership, gameplay, and community. It incentivizes activity through digital rewards directly tied to personal biometrics and achievements. Further examples of cryptographically secured digital collectables that may be received or evolved through usage of the present system include those described in U.S. Pat. Nos. 11,308,184 and 11,475,449, and in U.S. patent application Ser. No. 18/305,308, filed on 21 Apr. 2023, each of which is incorporated by reference in its entirety and for all that it discloses.

The technologies described herein broadly relate to devices that may assist and/or resist the ambulatory motion of a user. In some embodiments, the device may be configured to directly apply a torque to a user's foot or ankle in the least obtrusive manner possible. For example, in one configuration the device may include an ambulatory engine having a controller and a motor that is attached to or near the user's waste to minimize the perceivable weight of the system. The ambulatory engine may interconnect with the user's shoe via an intermediate cable that is selectively attachable to a connector provided on a posterior end portion of the shoe. In some embodiments, the interconnecting cable may be permanently or temporarily integrated into an article of clothing such as a pair of compression pants or other similar leg covering. In one configuration, the interconnecting cable may extend through a lumen formed at a seam where adjacent panels of material are joined. In configurations where the cable is temporarily fixed to the article of clothing, it may be done so, for example, using one or more temporary securing means such as hook and loop fasteners, snaps, or zippers. During use, the ambulatory engine may apply an assistive force to the user's foot to aid the user in pushing off during a walking or running gait via plantarflexion.

In an embodiment, an ambulatory assist device includes a waist-mounted ambulatory engine with a motor, controller, and sensors, that connects to the user's shoes via cables integrated into an article of clothing such as compression pants. The ambulatory engine controls the motor to provide assistive force to the user's ankles/feet during walking/running based on analyzing sensor data to determine gait phases. In a more specific embodiment, the ambulatory assist device may include a waist belt having an ambulatory engine that includes an embedded control module, communication circuitry in wireless communication with one or more body-mounted sensors, power supply, motor, and one or more onboard sensors including a gyroscope, accelerometer, and/or tension sensor. The waist belt is configured to encircle a user's waist and be worn during walking or running activities. The device further includes or is configured to be used with a pair of shoes configured to be worn on feet of the user, each shoe having a cable connector integrated into a posterior end portion of the respective shoe. An interconnecting cable, such as a Bowden cable may interconnect the motor with the connector on the shoe. In some embodiments, the interconnecting cable may be integrated into a lumen or seam of an article of clothing such as compression pants. The control module may be configured to analyze data from the on-board and/or body-mounted sensors to determine footstrike and leg swing phases of the user during walking or running. The controller may selectively actuate the motor in the ambulatory engine to tension the cables and provide an assistive plantarflexion torque to the cable connectors on the shoes during a detected terminal push off phase occurring just prior to leg swing.

In some embodiments, the motor may be controlled to achieve or otherwise follow one or more pre-established biomechanical movement patterns that are stored in memory prior to the user beginning the activity. During the activity, the controller may receive sensor data from one or more local sensor systems or remote sensor systems and may analyze this data to compare the user's real time biomechanical performance relative to the pre-established pattern. In some embodiments, the biomechanical movement pattern may include a particular or desired speed profile, energy expenditure, heart rate, foot strike pattern, form, joint motion, posture, or the like. Furthermore, while the overall use of the system may attempt to control or assist the user in achieving a particular movement pattern (e.g., speed or expended effort), specific actuation of the motor must be periodically timed to coincide with the push-off portion of the user's stride. To accomplish this, the controller may receive and analyze foot strike data to determine when the user is applying pressure against the sole of the shoe in the forefoot region while simultaneously reducing pressure against the sole in the heel region, and that this foot strike pattern is occurring while the user has an overall forward momentum/velocity. The specific timing of the application of force to the user's foot may further vary according to a known topographical profile of the local terrain and the user's sensed heading/direction of travel.

In an embodiment, a method for controlling an ambulatory assist device or external follower device may include developing a biomechanical movement template, collecting sensor data during an activity, analyzing the data to determine deviations from the template, and operating the motor to provide corrective torque/force based on the deviations. In a more specific embodiment, the present disclosure details a method of providing real-time gait assistance with a lightweight ambulatory exoskeleton device. The method includes storing a template of target joint motion profiles and ground reaction forces during an ambulatory activity such as running or walking; donning the exoskeleton device by a user, the device including a plurality of body-mounted sensors and one or more powered joint actuators; receiving motion and force sensor data associated with the user from the body-mounted sensors during the ambulatory activity; determining deviations in the joint motions and ground reaction forces from the template; identifying corrective torque profiles to be applied by the actuators to minimize the determined deviations; controlling the actuators to apply corrective torques to the user that are proportional to the corrective profiles; and in some embodiments, the device may provide visual or audio feedback to the user indicating specific deviations from the template when the deviations exceed threshold levels.

While the primary embodiments described above include a means for direct actuation of the user's shoe, in other embodiments the assistive or resistive force may be provided by an external chariot like follower device that is coupled to the user through one or more intermediate interconnecting devices such as rods, linkages, straps, or the like. In addition to the possibility of providing an assistive force to the user (e.g. to increase overall endurance), the follower device may also be configured to provide a varying resistive force against the user for the purpose of athletic training or conditioning. In some embodiments, the follower may include one or more seating surfaces that enable the user to pull passengers such as a child or a customer as a means of paid transportation. The follower may utilize one or more load sensors to determine an approximate mass of the passengers and or cargo and made dynamically adjust the amount of torque provided to the motor so that the total force required by the user remains unchanged regardless of the mass of the follower and any carried loads. This may prove exceptionally useful in stopping a heavy follower.

In an embodiment, a method of providing adaptive exercise assistance using an automated follower machine may begin, for example, by receiving a target heart rate profile or training goal for a user and determining a terrain map for a scheduled user run; applying a first assistive force to the user via a follower machine that includes an electric motor, a powered drive wheel, and is in communication with one or more sensors including a wearable biometric sensor on the body of the user, the follower machine being coupled to the user via a tether; receiving heart rate of the user via the wearable biometric sensor; comparing the monitored heart rate to the target heart rate profile for a current timepoint in the run; determining that the monitored heart rate deviates from the target profile by a threshold value, thus indicating overexertion by the user; in response to the determined deviation, adjusting the assistive force applied by the follower machine via the tether to a second assistive force to reduce strain on the user, the second assistive force being greater than the first assistive force; continuing to adjust the assistive force applied by the follower machine during the run to minimize the deviation of the user's heart rate from the target heart rate profile.

In some embodiments, the follower may integrate into an IoAAF system, and may selectively increase the applied resistive force as a prophylactic measure to prevent collisions between the user and one or more adjacent motor vehicles. In some embodiments, the follower may be configured with two independent drive wheels, and may be configured to provide navigation prompts or guidance to the user by varying the assistive or resistive forces applied between the two wheels. For example, if a left wheel is more assistive (or less resistive) than the right wheel, the follower may slightly urge the user in a rightward direction. This urging may serve as a navigation prompt to the user to turn right (e.g., at an intersection).

In an embodiment, the present disclosure further relates to integration of the ambulatory assist devices with a digital asset ecosystem. In such an embodiment, usage data may trigger distribution of rewards like digital collectibles, credits, or unique access. Achieving usage milestones can unlock or evolve blockchain-secured digital assets linked to the user's account. For example, a system for rewarding physical activity may include an ambulatory assist device that is configured to collect user movement data during exercise and transmit the collected data to a server. The server is then configured to convert the movement data into a plurality of digital points based on one or more pre-set conversion criteria and record the digital points to a user account. One or more digital collectible items may be associated with the user account that receives the digital points from exercising, and the server may then be configured to modify an appearance, performance, functionality, or utility of the digital collectible item when the accumulated points meet or exceed a predefined threshold.

Additional technology that can be incorporated into or used in conjunction with the present ambulatory assist device is provided in the following US Patent References, each of which are hereby incorporated by reference in their entirety and for all that they disclose: US Patent Application Pub. No. 2021/0368925 relating to footwear airbag technology with integrated sensors; US Patent Application Pub. No. 2023/0138485, relating to adaptive cushioning system for footwear; U.S. Pat. No. 9,908,027 relating to apparel and footwear systems; US Patent Application Pub. Nos. 2022/0202121, 2020/0375269, and 2022/0202104 relating to adaptive apparel; US Patent Application Pub. No. 2020/0368579 and U.S. Pat. No. 10,055,948 relating to haptic and/or ultrasonic feedback in apparel; and US Patent Application Pub. No. 2022/0193490 and U.S. Pat. Nos. 11,513,610 and 10,568,381 relating to gesture control. Each of these references details systems that can be used with the present ambulatory assist device for the purpose of sensing user motion or intention, providing feedback to the user for alert or navigation purposes, or for improving the user's form, ride, or endurance during use of the ambulatory assist device.

Aspects of this disclosure may be implemented, for example, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input(s). The software may also cooperate with other code segments to initiate a variety of tasks in response to data received in conjunction with the source of the received data. The software may be stored on any of a variety of memory media, such as CD-ROM, magnetic disk, solid-state drive (SSD), hard-disk drive (HDD), and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

As noted in the disclosure, the present system may utilize public or private blockchain infrastructures, distributed ledgers, append-only databases, and the like. In one example, the presently described cryptographically secured digital assets may initially be stored/secured to a private blockchain that resides on infrastructure maintained by a single entity, or consortium of entities. Each entity may agree upon a common form, or data construct for the infrastructure, though assets of any one entity may be maintained by that entity. Such a model may provide for the sharing of network and infrastructure costs/resources, while permitting each entity to maintain their own asset independence. To further public trust, assets created on this private or semi-private blockchain may be transferrable to public chains at the discretion of the user (potentially subject to one or more conditions of transfer).

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a solid-state drive (SSD) device, a hard-disk drive (HDD) device, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

Further aspects and embodiments of the present disclosure are provided in the following listing of clauses, which should be read in light of the disclosure above:

Clause 1. An ambulatory assist system comprising: an ambulatory engine configured to be mounted at a waist of a user, the ambulatory engine comprising a motor and a controller; an article of clothing wearable by the user and integrated with one or more cables coupled to the motor; one or more shoes wearable on feet of the user, each shoe coupled to a respective cable via a connector; and wherein the controller is configured to: receive sensor data from one or more sensors located on the user; analyze the sensor data to determine gait phases of the user; selectively control the motor to tension the one or more cables and provide an assistive force to the feet of the user during a push off phase of a gait cycle.

Clause 2. The system of clause 1, wherein the article of clothing comprises compression pants having lumens at seams, the one or more cables extending through the lumens.

Clause 3. The system of clause 1, wherein the ambulatory engine further comprises the one or more sensors located on the user, the sensors comprising at least one of: an accelerometer, gyroscope, or tension sensor.

Clause 4. The system of clause 1, wherein the one or more sensors comprises at least one sensor located in each shoe of the one or more shoes.

Clause 5. The system of clause 4, wherein the at least one sensor located in each shoe comprises a force sensor positioned to detect force applied to a sole of the shoe.

Clause 6. The system of clause 1, wherein the one or more sensors are configured to transmit the sensor data wirelessly to the controller.

Clause 7. The system of clause 1, wherein the controller is further configured to control a timing and magnitude of the assistive force based on the received sensor data.

Clause 8. The system of clause 1, wherein the controller is further configured to: store a biomechanical movement template; compare the sensor data to the template; and selectively control the motor based on a deviation between the sensor data and the template.

Clause 9. The system of clause 1, wherein the connector is located on a posterior portion of each shoe.

Clause 10. The system of clause 1, wherein the cable coupled to each shoe comprises a Bowden cable.

Clause 11. A method of providing ambulatory assistance with a lightweight assist device, the method comprising: receiving sensor data from one or more sensors located on an ambulatory assist device worn by a user; analyzing the sensor data to identify gait phases of the user; during a push off phase of a gait cycle, actuating a motor on the ambulatory assist device to tension one or more cables coupled between the motor and shoes worn by the user, thereby providing an assistive force to feet of the user.

Clause 12. The method of clause 11, wherein analyzing the sensor data comprises: comparing the sensor data to a pre-stored biomechanical movement template; and identifying deviations between the sensor data and the template.

Clause 13. The method of clause 12, further comprising: controlling a timing and magnitude of the assistive force based on the identified deviations.

Clause 14. The method of clause 11, wherein the ambulatory assist device comprises: an ambulatory engine configured to be mounted at a waist of the user, the ambulatory engine comprising the motor and a controller; an article of clothing wearable by the user and integrated with the one or more cables.

Clause 15. The method of clause 11, wherein the sensor data is received from sensors located in shoes worn by the user and from sensors located on the ambulatory assist device.

Clause 16. A method for controlling an ambulatory assist device, the method comprising: storing a biomechanical movement template in a memory of the ambulatory assist device; receiving sensor data from one or more sensors during a user activity; analyzing the sensor data to identify deviations from the biomechanical movement template; determining corrective forces based on the identified deviations; and selectively operating a motor to apply the corrective forces to the user.

Clause 17. The method of clause 16, wherein the biomechanical movement template comprises a target gait pattern including foot strike characteristics.

Clause 18. The method of clause 166, wherein receiving sensor data comprises receiving data from one or more sensors located on the ambulatory assist device and one or more sensors worn by the user.

Clause 19. The method of clause 16, wherein analyzing the sensor data comprises using a control algorithm executed by a processor to compare the sensor data to the biomechanical movement template.

Clause 20. The method of clause 16, further comprising providing feedback to the user when the identified deviations exceed a threshold value.

Clause 21. The method of clause 16, wherein determining corrective forces comprises calculating torque values for each joint of the user to minimize the identified deviations.

Clause 22. The method of clause 16, wherein selectively operating the motor comprises applying the corrective forces to the user in real-time during the activity.

Clause 23. The method of clause 16, further comprising modifying the stored biomechanical movement template based on past performance of the user.

Clause 24. A method for controlling a follower assist device, the method comprising: storing a target performance template for a training activity; monitoring performance of a user during the training activity; identifying deviations between the monitored performance and the target performance template; determining modifications to an assistive force applied to the user by the follower assist device to minimize the identified deviations; controlling the follower assist device to apply the modified assistive force.

Clause 25. The method of clause 24, wherein the target performance template comprises a target heart rate profile.

Clause 26. The method of clause 24, wherein monitoring performance comprises receiving heart rate data from a biometric sensor worn by the user.

Clause 27. The method of clause 24, wherein the modifications to the assistive force include at least one of magnitude, direction, or timing.

Clause 28. The method of clause 24, further comprising updating the target performance template based on past performance of the user.

Clause 29. The method of clause 24, wherein the follower assist device is coupled to the user and applies the assistive force via a tether.

Clause 30. The method of clause 24, further comprising providing feedback to the user when the identified deviations exceed a threshold.

Clause 31. A system for rewarding physical activity, comprising: an ambulatory assist device configured to collect user movement data during exercise and transmit the collected data to a server; wherein the server is configured to: convert the movement data into a plurality of digital points based on one or more pre-set conversion criteria; record the digital points to a user account; and modify an appearance, performance, or utility of a digital collectible item associated with the user account when the accumulated points meet or exceed a predefined threshold.

Clause 31. The system of clause 31, wherein the ambulatory assist device is configured to be worn by the user during activities including walking, running, or jumping.

Clause 32. The system of clause 31, wherein the movement data includes at least one of steps, distance, calories, heart rate, or exercise duration.

Clause 33. The system of clause 31, wherein the digital collectible item comprises a blockchain-registered non-fungible token.

Clause 34. The system of clause 34, wherein modifying the digital collectible item comprises evolving the non-fungible token.

Clause 35. The system of clause 31, wherein the predefined threshold is variable based on a rarity of the digital collectible item.

Clause 36. The system of clause 31, wherein the digital points are usable by the user in a metaverse environment.

Clause 37. The system of clause 31, wherein the server is further configured to grant the user unique access to digital content when the accumulated points exceed the predefined threshold.

Clause 38. The system of clause 31, wherein exceeding the predefined threshold permanently alters the digital collectible item.

Clause 39. The system of clause 31, wherein the modification comprises changing a visual appearance of an avatar associated with the user account.

Clause 40. A method for rewarding physical activity, comprising: receiving user movement data from an ambulatory assist device at a server; converting the movement data into digital fitness tokens based on pre-defined rules; allocating the digital fitness tokens to a user account; providing a digital collectible item to the user account; and modifying the digital collectible item when the user account accumulates a threshold quantity of the digital fitness tokens.

Clause 41. The method of clause 41, wherein the movement data includes exercise duration and the pre-defined rules allocate tokens proportional to duration.

Clause 42. The method of clause 41, wherein modifying the digital collectible item comprises evolving the item.

Clause 43. The method of clause 41, wherein the digital collectible item is associated with a metaverse environment.

Clause 44. The method of clause 41, further comprising enabling the user to access restricted digital content when accumulating the threshold quantity of tokens.

What is claimed:

1. An ambulatory assist system comprising:
an ambulatory engine configured to be mounted at a waist of a user, the ambulatory engine comprising a motor and a controller;
an article of clothing wearable by the user and integrated with one or more cables coupled to the motor;
one or more shoes wearable on feet of the user, each shoe coupled to a respective cable via a connector; and
wherein the controller is configured to: receive sensor data from one or more sensors located on the user; analyze the sensor data to determine gait phases of the user; selectively control the motor to tension the one or more cables and provide an assistive force to the feet of the user during a push off phase of a gait cycle.

2. The system of claim 1, wherein the article of clothing comprises compression pants having lumens at seams, the one or more cables extending through the lumens.

3. The system of claim 1, wherein the ambulatory engine further comprises the one or more sensors located on the user, the sensors comprising at least one of: an accelerometer, gyroscope, or tension sensor.

4. The system of claim 1, wherein the one or more sensors comprises at least one sensor located in each shoe of the one or more shoes.

5. The system of claim 4, wherein the at least one sensor located in each shoe comprises a force sensor positioned to detect force applied to a sole of the shoe.

6. The system of claim 1, wherein the one or more sensors are configured to transmit the sensor data wirelessly to the controller.

7. The system of claim 1, wherein the controller is further configured to control a timing and magnitude of the assistive force based on the received sensor data.

8. The system of claim 1, wherein the controller is further configured to: store a biomechanical movement template; compare the sensor data to the template; and selectively control the motor based on a deviation between the sensor data and the template.

9. The system of claim 1, wherein the connector is located on a posterior portion of each shoe.

10. The system of claim 1, wherein the cable coupled to each shoe comprises a Bowden cable.

11. A method of providing ambulatory assistance with a lightweight assist device, the method comprising:
receiving sensor data from one or more sensors located on an ambulatory assist device worn by a user;
analyzing the sensor data to identify gait phases of the user;
during a push off phase of a gait cycle, actuating a motor on the ambulatory assist device to tension one or more cables coupled between the motor and shoes worn by the user, thereby providing an assistive force to feet of the user.

12. The method of claim 11, wherein analyzing the sensor data comprises: comparing the sensor data to a pre-stored biomechanical movement template; and identifying deviations between the sensor data and the template.

13. The method of claim 12, further comprising: controlling a timing and magnitude of the assistive force based on the identified deviations.

14. The method of claim 11, wherein the ambulatory assist device comprises: an ambulatory engine configured to be mounted at a waist of the user, the ambulatory engine comprising the motor and a controller; an article of clothing wearable by the user and integrated with the one or more cables.

15. The method of claim 11, wherein the sensor data is received from sensors located in shoes worn by the user and from sensors located on the ambulatory assist device.

16. An ambulatory assist device comprising:
a waist belt having an embedded control module in communication with a plurality of sensors, the waist belt configured to encircle a user's waist and be worn during walking or running activities;
a pair of shoes configured to be worn on feet of the user, each shoe having a cable connector integrated into a heel counter on a rear portion of the shoe;
a pair of elastic compression pants configured to be worn by the user having a plurality of Bowden cables integrated into seams on sides of the pants, the cables connecting to the motor in the waist belt and having terminal ends that couple to the cable connectors on the shoes;
wherein the control module analyzes the received data from the plurality of sensors to determine footstrike and leg swing phases of the user during walking or running, and selectively actuates the tension sensors in the waist belt to tension the Bowden cables and provide an assistive plantarflexion torque to the cable connectors on the shoes during a detected terminal push off phase occurring just prior to leg swing.
